(19) United States
(12) Patent Application Publication
(10) Pub. No.: US 2026/0021854 A1
(43) Pub. Date: Jan. 22, 2026

(54) CONVEYANCE SKIN MATERIAL AND CONVEYANCE SEAT

(71) Applicant: TS TECH CO., LTD., Asaka-shi, Saitama (JP)

(72) Inventors: Kazuhiro TSURUMI, Tochigi (JP); Kenshiro WAKAO, Tochigi (JP); Takuma WATANABE, Tochigi (JP); Munetaka KOWA, Tochigi (JP); Hayato SHIDA, Tochigi (JP); Miki MATSUMOTO, Tochigi (JP); Takuto KOJIMA, Tochigi (JP); Hiroki ITO, Tochigi (JP)

(21) Appl. No.: 19/111,923

(22) PCT Filed: Sep. 13, 2023
(86) PCT No.: PCT/JP2023/033462

§ 371 Date: Mar. 14, 2025

Related U.S. Application Data
(60) Provisional application No. 63/406,315, filed on Sep. 14, 2022.
(60) Provisional application No. 63/377,913, filed on Sep. 30, 2022.
(60) Provisional application No. 63/424,237, filed on Nov. 10, 2022.
(60) Provisional application No. 63/497,465, filed on Apr. 21, 2023.

(30) Foreign Application Priority Data
Mar. 30, 2023 (JP) 2023-055125
Sep. 12, 2023 (JP) 2023-147638
Sep. 12, 2023 (JP) 2023-147639

(51) Int. Cl. B62J 1/18; B32B 1/00; B32B 5/18; B32B 7/09; B32B 27/06; B32B 27/30; B32B 27/32; B32B 27/40; B60N 2/56; B60N 2/72; B62J 45/00

(52) U.S. Cl. CPC B62J 1/18; B32B 1/00; B32B 5/18; B32B 7/09; B32B 27/065; B32B 27/304; B32B 27/32; B32B 27/40; B60N 2/56; B60N 2/72; B62J 45/00; B32B 2266/0278; B32B 2307/7265; B32B 2601/00

(57) ABSTRACT

A conveyance skin material includes a first skin material; a second skin material connected to the first skin material; and a waterproof member having a sheet shape, extending along a skin connecting portion that connects the first skin material and the second skin material, and covering the skin connecting portion from a back surface side. The waterproof member includes a first impregnated portion with which a back surface material of the first skin material is impregnated, and a second impregnated portion with which a back surface material of the second skin material is impregnated. The waterproof member is attached to the first skin material by the first impregnated portion, and is attached to the second skin material by the second impregnated portion. The first impregnated portion and the second impregnated portion are disposed at positions where the skin connecting portion is sandwiched between the first impregnated portion and the second impregnated portion.

### TECHNICAL FIELD

The present invention relates to a conveyance skin material and a conveyance seat, particularly to a conveyance skin material and a conveyance seat used in a conveyance.

### BACKGROUND ART

Conventionally, a saddle-type conveyance seat including a bottom plate; a pad material placed on the bottom plate; and a skin material that covers the bottom plate and the pad material has been known (for example, refer to PATENT LITERATURE 1).

A conveyance seat described in PATENT LITERATURE 1 is a motorized two-wheeled vehicle exposed to wind and rain or snow. Therefore, a skin material is formed from a water-resistant resin material such as polyvinyl chloride. In addition, in order to prevent water from leaking from a skin connecting portion between a first skin material and a second skin material constituting the skin material, a waterproof member (waterproof tape) having a sheet shape is attached to a back surface of the skin connecting portion.

### CITATION LIST

### Patent Literature

PATENT LITERATURE 1: JP S60-55589 U

### SUMMARY OF INVENTION

### Technical Problem

Meanwhile, there has been a demand to further enhance waterproof performance in conveyance seats as described in PATENT LITERATURE 1.

For example, even when the waterproof member (waterproof tape) is attached to the skin connecting portion between the first skin material and the second skin material constituting the skin material, water enters through a gap of the skin connecting portion, and water travels through a back surface material (base fabric) of the skin material to leak onto a pad material, which is a risk.

The present invention has been made in view of the above-described problems, and an object of the present invention is to provide a conveyance skin material and a conveyance seat capable of enhancing waterproof performance compared to the conventional art.

### Solution to Problem

The above-described problems are solved by a conveyance skin material of the present invention that is used for a conveyance, the conveyance skin material including: a first skin material; a second skin material attached in a state where the second skin material partially overlaps the first skin material; and a waterproof member having a sheet shape, extending along a skin connecting portion where the first skin material and the second skin material overlap each other, and covering the skin connecting portion from a back surface side of the conveyance skin material. The waterproof member includes a first impregnated portion with which a back surface material of the first skin material is impregnated, and a second impregnated portion with which a back surface material of the second skin material is impregnated. The waterproof member is attached to the first skin material by the first impregnated portion, and is attached to the second skin material by the second impregnated portion. The first impregnated portion and the second impregnated portion are disposed at positions where the skin connecting portion is sandwiched between the first impregnated portion and the second impregnated portion.

With the above-described configuration, the conveyance skin material capable of enhancing waterproof performance compared to the conventional art can be realized.

In detail, in the conveyance skin material, the waterproof member includes the first impregnated portion with which the back surface material of the first skin material is impregnated, and the second impregnated portion with which the back surface material of the second skin material is impregnated. The waterproof member is attached to the first skin material by the first impregnated portion, and is attached to the second skin material by the second impregnated portion. Furthermore, the first impregnated portion and the second impregnated portion are disposed at positions where the skin connecting portion is sandwiched between the first impregnated portion and the second impregnated portion. Therefore, even when water enters through a gap of the skin connecting portion, and water travels through the back surface material (for example, base fabric) of the skin material, the entry of water can be suppressed by the first impregnated portion and the second impregnated portion. Namely, water that has entered from the skin connecting portion can be contained by the first impregnated portion and the second impregnated portion located at positions where the skin connecting portion is sandwiched therebetween.

In this case, it is preferable that the waterproof member includes a waterproof body portion that comes into contact with a back surface of the skin connecting portion, a first end portion that is provided at one end portion of the waterproof member in a width direction and that comes into contact with a back surface of the first skin material, and a second end portion that is provided at the other end portion of the waterproof member in the width direction and that comes into contact with a back surface of the second skin material. It is preferable that the first impregnated portion is formed at least at a boundary portion between the waterproof body portion and the first end portion. It is preferable that the second impregnated portion is formed at least at a boundary portion between the waterproof body portion and the second end portion.

As described above, since the first impregnated portion is formed at least at the boundary portion between the waterproof body portion and the first end portion, and the second impregnated portion is formed at least at the boundary portion between the waterproof body portion and the second end portion, water that has entered from the skin connecting portion at the boundary portion can be stopped. Namely, the leakage of water, which has entered from the skin connecting portion, onto the pad material can be suitably suppressed.

In this case, it is preferable that the skin connecting portion is folded toward a second skin material side and disposed on the back surface side of the conveyance skin material, and is attached in a folded state by a stitching portion. It is preferable that the second impregnated portion passes through the back surface material of the folded second skin material, and extends from the boundary portion between the waterproof body portion and the second end portion toward the stitching portion.

With the above-described configuration, water entering from the skin connecting portion through the stitching portion, traveling through the back surface material, and leaking onto the pad material can be suitably suppressed.

In this case, it is preferable that the skin connecting portion is folded toward a second skin material side and disposed on the back surface side of the conveyance skin material, and is attached in a folded state by a stitching portion. It is preferable that the stitching portion extends along the skin connecting portion. It is preferable that the first impregnated portion and the second impregnated portion extend along the stitching portion.

With the above-described configuration, water that has entered through the stitching portion can be suitably stopped.

In this case, it is preferable that the waterproof member includes the first impregnated portion, the second impregnated portion, and a third impregnated portion with which a back surface material of the skin connecting portion is impregnated, and which is formed continuously with the first impregnated portion and the second impregnated portion. It is preferable that the first impregnated portion, the second impregnated portion, and the third impregnated portion extend continuously along the stitching portion.

With the above-described configuration, the waterproof performance provided by the waterproof member can be further enhanced. In addition, water that has entered through the stitching portion can be suitably stopped.

In this case, it is preferable that the conveyance skin material further includes a decorative member attached between a first skin connecting portion of the first skin material and a second skin connecting portion of the second skin material, the first skin connecting portion and the second skin connecting portion constituting the skin connecting portion, and exposed on a front surface of the conveyance skin material. It is preferable that the waterproof member includes the first impregnated portion, the second impregnated portion, and a third impregnated portion with which a back surface material of the skin connecting portion is impregnated. It is preferable that a part of the third impregnated portion is provided at a position facing an end portion of the decorative member.

With the above-described configuration, the decorative member can be suitably attached. In addition, water that has entered through a gap between the first skin material (second skin material) and the decorative member can be suitably stopped by the third impregnated portion.

In this case, it is preferable that a conveyance seat includes the conveyance skin material described above; and a pad material covered with the conveyance skin material. It is preferable that the skin connecting portion and the waterproof member are accommodated in a pad recess formed on a front surface of the pad material.

With the above-described configuration, the lifting of the skin connecting portion of the skin material can be suppressed, and the degradation of the design of the skin material can be suppressed. In addition, an increase in the size of the conveyance seat can also be suppressed.

In addition, with the above-described configuration, the pressure applied to the skin connecting portion due to a seating load can be reduced. Namely, stress such as pressure or abrasion on the stitching portion or the waterproof member can be reduced, and the durability of the material can be improved. In addition, waterproof performance can also be enhanced.

In this case, it is preferable that the waterproof member includes a waterproof body portion that comes into contact with a back surface of the skin connecting portion, a first end portion that is provided at one end portion of the waterproof member in a width direction and that comes into contact with a back surface of the first skin material, and a second end portion that is provided at the other end portion of the waterproof member in the width direction and that comes into contact with a back surface of the second skin material. It is preferable that each of the first end portion and the second end portion comes into contact with the front surface of the pad material.

With the above-described configuration, the waterproof member can be suitably attached in a state where the waterproof member is sandwiched between the pad material and the skin material. In addition, the peeling of the waterproof member can be suppressed.

In this case, it is preferable that a bottom plate, the pad material disposed on the bottom plate, and the conveyance skin material covering the bottom plate and the pad material are provided. It is preferable that a plurality of through-holes are formed on a front surface of the bottom plate. It is preferable that at least a part of the skin connecting portion is disposed at a position overlapping the through-holes of the bottom plate when the conveyance seat is viewed from above.

With the above-described configuration, a load from a seated occupant can be released (dispersed) through the through-holes, and the load applied to the waterproof member can be reduced. Therefore, the deterioration of the waterproof member can be suppressed.

In this case, it is preferable that the conveyance seat further includes a seat heater disposed between the pad material and the conveyance skin material. It is preferable that the seat heater is disposed on a front surface of the conveyance skin material at a position different from a position of the waterproof member.

With the above-described configuration, the influence of heat of the seat heater on the impregnated portions of the waterproof member can be suppressed. For example, a decrease in the adhesive strength of the waterproof member can be suppressed.

### Advantageous Effects of Invention

According to the present invention, the conveyance skin material capable of enhancing waterproof performance compared to the conventional art can be realized. Specifically, even when water enters through the gap of the skin connecting portion, and water travels through the back surface material of the skin material, the entry of water can be suppressed by the first impregnated portion and the second impregnated portion.

In addition, according to the present invention, the leakage of water, which has entered from the skin connecting portion, onto the pad material can be suitably suppressed.

In addition, according to the present invention, water entering from the skin connecting portion through the stitching portion, traveling through the back surface material, and leaking onto the pad material can be suitably suppressed.

In addition, according to the present invention, the waterproof performance provided by the waterproof member can be further enhanced. In addition, water that has entered through the stitching portion can be suitably stopped.

In addition, according to the present invention, the decorative member can be suitably attached. In addition, water that has entered through the gap between the first skin material (second skin material) and the decorative member can be suitably stopped by the third impregnated portion.

In addition, according to the present invention, the lifting of the skin connecting portion of the skin material can be suppressed, and the degradation of the design of the skin material can be suppressed. In addition, an increase in the size of the conveyance seat can also be suppressed. In addition, the pressure applied to the skin connecting portion due to the seating load can be reduced.

In addition, according to the present invention, the waterproof member can be suitably attached in a state where the waterproof member is sandwiched between the pad material and the skin material. In addition, the peeling of the waterproof member can be suppressed.

In addition, according to the present invention, the load from the seated occupant can be released through the through-holes. Therefore, the load applied to the waterproof member can be reduced, and the deterioration of the waterproof member can be suppressed.

In addition, according to the present invention, the influence of heat of the seat heater on the impregnated portions of the waterproof member can be suppressed (a decrease in the adhesive strength of the waterproof member can be suppressed).

### BRIEF DESCRIPTION OF DRAWINGS

FIG. 1 is a perspective view of conveyance seat of a first embodiment.

FIG. 2 is a cross-sectional view taken along line II-II of FIG. 1, and is a view showing a bottom plate, a pad material, a skin material, and a waterproof member.

FIG. 3 is an enlarged view of a main portion of FIG. 2, and is a view showing a skin connecting portion and the waterproof member.

FIG. 4 is an enlarged view of the main portion of FIG. 2, and is a view showing a positional relationship between the skin connecting portion, the waterproof member, and the bottom plate.

FIG. 5 is an enlarged view of a main portion of a skin connecting portion and a waterproof member in a conveyance seat of a second embodiment.

FIG. 6 is an enlarged view of a main portion of a skin connecting portion, a waterproof member, and a decorative member in a conveyance seat of a third embodiment.

FIG. 7 is a perspective view of a conveyance seat of a fourth embodiment.

FIG. 8 is perspective view of a conveyance seat of a fifth embodiment.

FIG. 9 is a perspective view of a conveyance seat of a sixth embodiment.

FIG. 10 is a cross-sectional view taken along line X-X of FIG. 9, and is a view showing a bottom plate, a pad material, a skin material, and a waterproof member.

FIG. 11 is an enlarged view of a main portion of FIG. 10, and is a view showing a skin overlapping portion and the waterproof member.

FIG. 12 is an enlarged view of the main portion of FIG. 10, and is a view showing a positional relationship between the skin overlapping portion, the waterproof member, and a bottom plate.

FIG. 13 is an enlarged view of a main portion of a skin overlapping portion, a waterproof member, and a bottom plate in a conveyance seat of a seventh embodiment.

FIG. 14 is an enlarged view of a main portion of a skin overlapping portion and a waterproof member in a conveyance seat of an eighth embodiment.

FIG. 15 is a perspective view of a conveyance seat of a ninth embodiment.

FIG. 16 is a cross-sectional view taken along line XVI-XVI of FIG. 15.

FIG. 17 is a side view of an electric two-wheeled vehicle of the first embodiment.

FIG. 18 is a front view of the electric two-wheeled vehicle when viewed from behind.

FIG. 19 is a side view showing a state where first batteries of the electric two-wheeled vehicle are disposed above a battery receiving portion.

FIG. 20 is a side view showing a state where the first batteries of the electric two-wheeled vehicle are disposed in the battery receiving portion.

FIG. 21 is a side view showing a state where first batteries of an electric two-wheeled vehicle of a second embodiment are disposed in a battery receiving portion.

FIG. 22 is a side view showing a state where the first batteries of the electric two-wheeled vehicle are disposed above the battery receiving portion.

FIG. 23 is a side view showing a state where first batteries of an electric two-wheeled vehicle of a third embodiment are disposed in a battery receiving portion.

FIG. 24 is a side view showing a state where the first batteries of the electric two-wheeled vehicle are disposed rearward from the battery receiving portion.

FIG. 25 is a side view of an electric two-wheeled vehicle of a fourth embodiment.

FIG. 26 is a front view of the electric two-wheeled vehicle when viewed from behind.

FIG. 27 is a side view showing a state where first batteries of the electric two-wheeled vehicle are disposed above a battery receiving portion.

FIG. 28 is a side view showing a state where the first batteries of the electric two-wheeled vehicle are disposed in the battery receiving portion.

### DESCRIPTION OF EMBODIMENTS

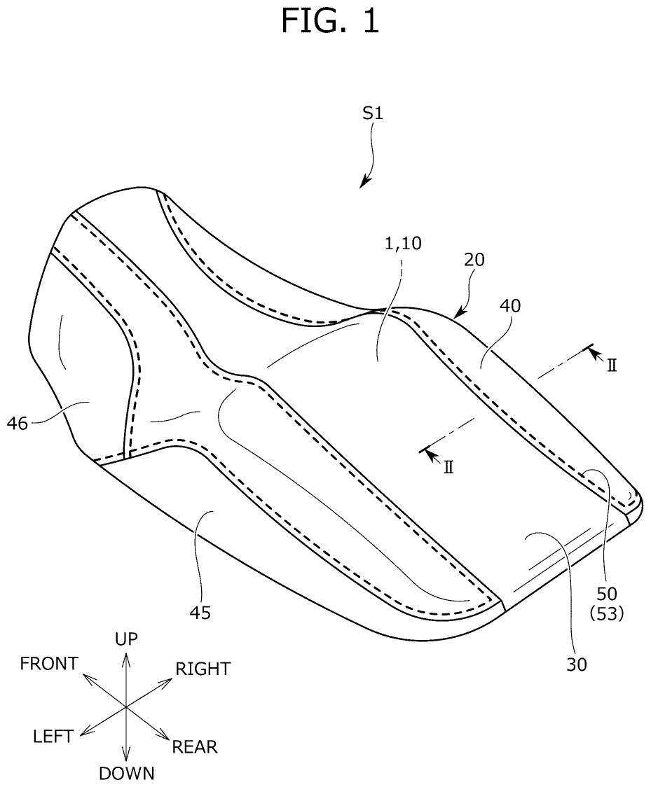

Hereinafter, embodiments according to the present invention will be described with reference to FIGS. 1 to 28.

Incidentally, a side on which handlebars of a conveyance are disposed with respect to a conveyance seat is a seat front side (front side).

### Conveyance Seat of First Embodiment

As shown in FIGS. 1 to 4, a conveyance seat S1 of a first embodiment is a seat constituting a seating portion of a motorized two-wheeled vehicle, and is a saddle-type seat that is directly exposed to sunlight or directly exposed to wind and rain or snow. Hereinafter, the conveyance seat S1 will also be referred to simply as the seat S1.

The conveyance seat S1 includes a bottom plate 1 attached onto a vehicle body and serving as a base substrate; a pad material 10 placed on the bottom plate 1; a skin material 20 (a first skin material 30 and a second skin material 40) that covers the bottom plate 1 and the pad material 10; a stitching portion 50 that attaches the first skin material 30 and the second skin material 40 to each other in a state where the first skin material 30 and the second skin material 40 are partially overlapped; and a waterproof member 60 having a sheet shape and attached to a back surface of the skin material 20.

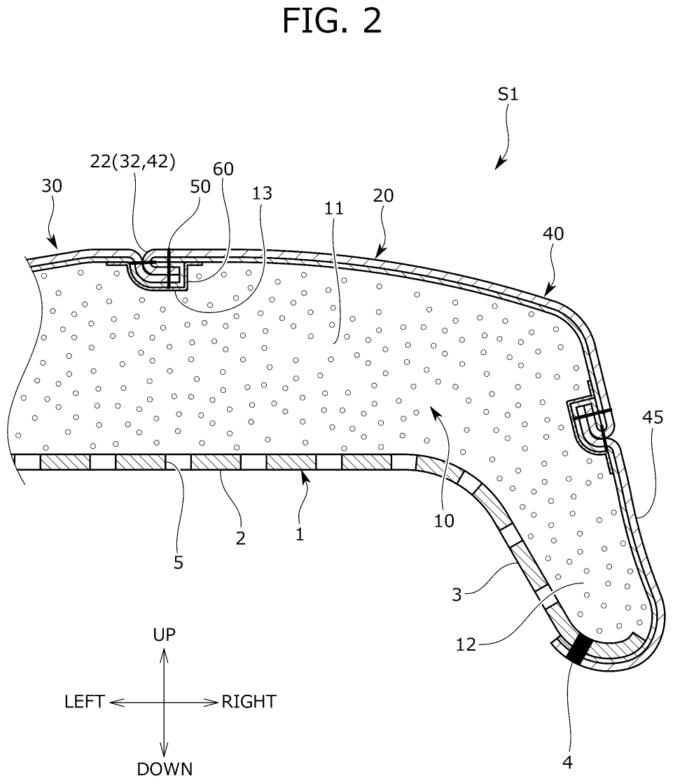

Incidentally, in the conveyance seat S1, as shown in FIG. 2, skin terminal treatment is performed by attaching a terminal portion of the skin material 20 to a back surface of the bottom plate 1. Specifically, an attaching member 4 such as a tacker needle is used for the skin terminal treatment.

As shown in FIG. 2, the bottom plate 1 is a plate that is long in a seat front to rear direction, and is a base substrate of the seat S1, which is formed in a curved shape to match the outer shape of the vehicle body.

Specifically, the bottom plate 1 is mainly composed of a plate body portion 2 serving as a body portion of the bottom plate 1, and a plate outer peripheral portion 3 serving as a flange portion formed by bending an outer peripheral portion of the plate body portion 2 diagonally downward.

The bottom plate 1 is formed as a synthetic resin-molded product using a resin material such as polypropylene or polyethylene as a raw material.

Incidentally, the bottom plate 1 is not limited to being formed from the above-described resin material, and may be formed from various materials. For example, a resin material having a relatively high bending modulus, such as glass fiber-reinforced polypropylene (GFPP), may be used as the raw material.

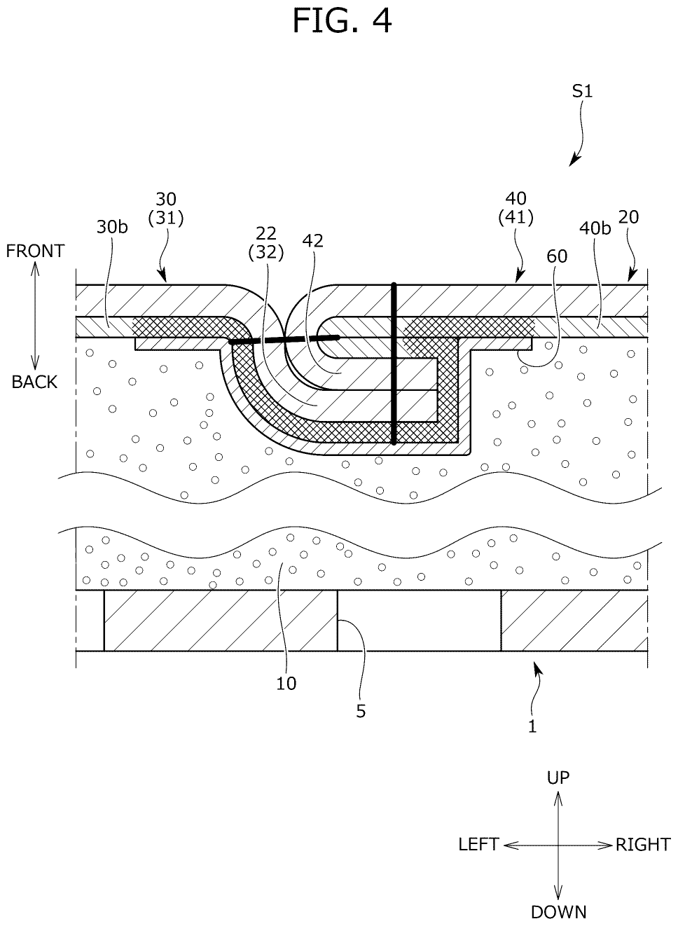

As shown in FIGS. 2 and 4, a plurality of through-holes 5 penetrating through the bottom plate 1 in an up to down direction are formed on a front surface of the bottom plate 1. Each of the through-holes 5 is a ventilation hole for ensuring the breathability of the seat S1, and is also referred to as an air release hole.

As shown in FIGS. 1 to 4, the pad material 10 is a cushion pad that is made of an elastic member such as urethane foam and that is long in the seat front to rear direction, and is formed to be slightly larger than the outer shape of the bottom plate 1.

Specifically, the pad material 10 includes a pad body portion 11 serving as a body portion of the pad material 10, and a pad projecting portion 12 projecting from an outer peripheral portion of the pad body portion 11, and extending along a front surface of the plate outer peripheral portion 3 of the bottom plate 1.

As shown in FIG. 2, the pad projecting portion 12 is provided to surround substantially the entire periphery of the bottom plate 1 from the outside.

A pad recess 13 recessed toward a back surface side of the pad material 10 is formed in a portion of a front surface of the pad material 10, the portion facing a skin connecting portion 22 that connects the first skin material 30 and the second skin material 40. The skin connecting portion 22 is accommodated in the pad recess 13.

By providing the pad recess 13, the lifting of the skin connecting portion 22 of the skin material 20 can be suppressed, and the degradation of the design of the skin material 20 can be suppressed.

In addition, by providing the pad recess 13, the pressure applied to the skin connecting portion 22 due to a seating load can be reduced. Namely, stress such as pressure or abrasion on the stitching portion 50 or the waterproof member 60 can be reduced, and the durability of the material can be improved. Waterproof performance can also be enhanced.

It is preferable that the recessed shape is set to be large for a portion of the conveyance seat S1 corresponding to the seating portion on which an occupant is seated. Meanwhile, it is preferable that the recessed shape is set to be slightly small for a portion not corresponding to the seating portion. Therefore, discomfort felt when seated on the skin connecting portion 22 can be reduced.

Incidentally, the pad recess 13 may not necessarily be formed in the pad material 10. In that case, the productivity of the pad material 10 can be improved.

As shown in FIGS. 1 to 4, the skin material 20 is a covering material constituting the appearance of the seat S1, is made of a covering material such as polyvinyl chloride (PVC) leather, and is formed, for example, by bonding a soft polyvinyl chloride layer to a front surface of a fabric.

Specifically, the skin material 20 includes a front surface material 20a made of a covering material, and a back surface material 20b made of a fabric and bonded to a back surface of the front surface material 20a.

Impregnated portions 64, 65, and 66 (impregnated adhesive portions) are formed by impregnating a part of the back surface material 20b (specifically, a portion of the back surface material 20b to which the waterproof member 60 is attached) with an adhesive layer 60b of the waterproof member 60.

By employing polyvinyl chloride leather or the like as the material for the skin material 20 (front surface material 20a), the material is made suitable as a skin material for a motorized two-wheeled vehicle which is directly exposed to wind and rain.

In addition, by forming the front surface material 20a from a material that is relatively difficult to stretch, the attachment strength of the front surface material 20a can be ensured while ensuring the design of the front surface of the seat (while preventing wrinkles or looseness from occurring).

The skin material 20 includes the first skin material 30 constituting an upper surface of the seat S1; the second skin material 40 constituting the upper surface and side surfaces of the seat S1; a third skin material 45 constituting lower portions of the side surfaces and a bottom surface of the seat S1; and a fourth skin material 46 constituting both front side surfaces of the seat S1.

In other words, it can be said that the skin material 20 is mainly composed of a first skin piece (first skin material 30), a second skin piece (second skin material 40), a third skin piece (third skin material 45), and a fourth skin piece (fourth skin material 46).

Incidentally, the skin material 20 may be composed of two skin materials (the first skin material 30 and the second skin material 40), or may be composed of three or more skin materials.

The first skin material 30 includes a first skin body 31 serving as a body portion of the first skin material 30, and a first skin connecting portion 32 that is provided at an end portion of the first skin body 31, and that overlaps the second skin material 40.

The first skin connecting portion 32 may be referred to as a first skin terminal portion.

The second skin material 40 includes a second skin body 41 serving as a body portion of the second skin material 40, and a second skin connecting portion 42 that is provided at an end portion of the second skin body 41, and that overlaps the first skin connecting portion 32.

The second skin connecting portion 42 may be referred to as a second skin terminal portion.

The third skin material 45 and the fourth skin material 46 have the same configuration. Specifically, as shown in FIG. 1, the third skin material 45 and the fourth skin material 46 are attached to the second skin material 40 in a state where the third skin material 45 and the fourth skin material 46 partially overlap the second skin material 40.

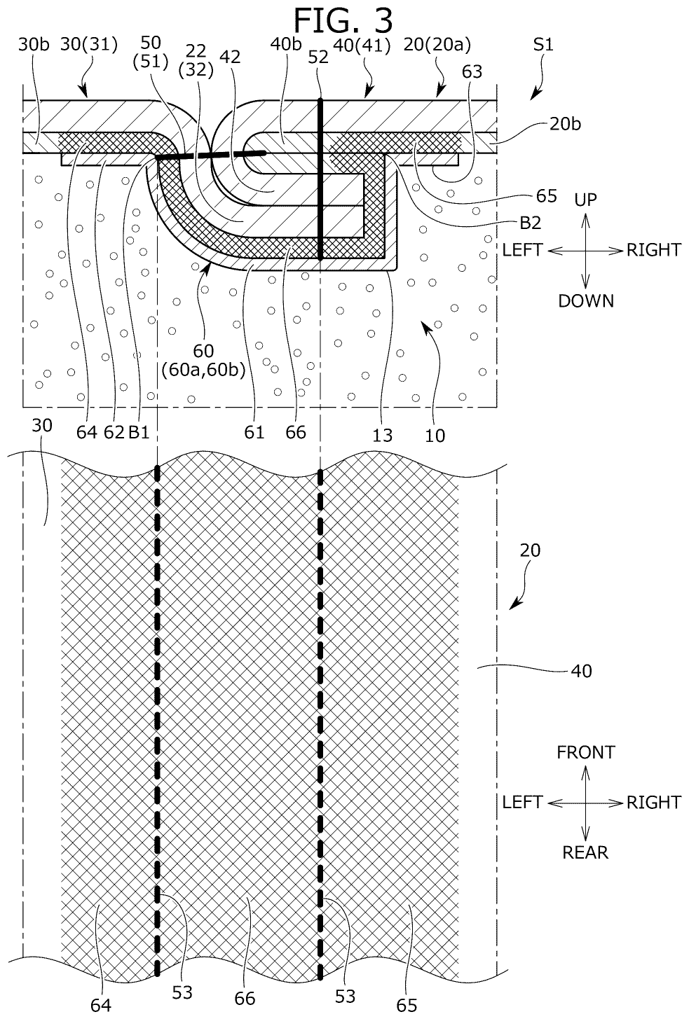

As shown in FIGS. 2 and 3, the first skin material 30 is attached to the second skin material 40 by the stitching portion 50 in a state where the first skin material 30 partially overlaps the second skin material 40.

Specifically, the skin connecting portion 22 (the first skin connecting portion 32 and the second skin connecting portion 42) is folded toward a second skin material 40 side on a back surface side of the skin material 20. Then, the first skin connecting portion 32 and the second skin connecting portion 42 are stitched together by the stitching portion 50. The skin connecting portion 22 may be referred to as a skin overlapping portion.

The first skin connecting portion 32 is disposed closer to the back surface side than the second skin connecting portion 42 in a thickness direction of the skin material 20.

As shown in FIGS. 2 and 3, the stitching portion 50 includes a first stitching portion 51 that stitches together the first skin connecting portion 32 and the second skin connecting portion 42, and a second stitching portion 52 that stitches together the first skin connecting portion 32, the second skin connecting portion 42, and the second skin body 41.

Incidentally, as shown in FIG. 1, stitching lines 53 are formed on a front surface of the skin material 20 by stitching together the first skin material 30 and the second skin material 40. The stitching line 53 extends over a long length along the skin connecting portion 22.

It is preferable that the stitching portion 50 is a single stitch as shown in FIG. 3; however, the stitching portion 50 is not particularly limited thereto, and various sewing specifications can be employed.

Specifically, sewing g specifications such as seam stitching (plain stitching), double stitching, single-side double stitching, dummy double stitching, and embroidery may be employed.

As shown in FIGS. 2 to 4, the waterproof member 60 is, for example, a waterproof tape, extends over a long length along the skin connecting portion 22 (the first skin connecting portion 32 and the second skin connecting portion 42), and is attached to cover the skin connecting portion 22 from the back surface side.

The waterproof member 60 is formed from polyurethane resin or the like, and includes a base material 60a having stretchability (water-resistant base material or waterproof base material), and the adhesive layer 60b provided on the base material 60a and having adhesive properties.

It is preferable that the base material 60a is formed from polyurethane resin. By employing polyurethane resin, the stretchability of the base material 60a can be increased, and the followability of the base material 60a to the skin material 20 can be enhanced. For example, an elongation of the base material 60a made of polyurethane resin is 500% or more at room temperature.

The base material 60a may be made of ethylene-vinyl acetate copolymer resin (EVA) or the like in addition to polyurethane resin. Namely, various resin materials can be employed as long as the elongation of the base material 60a is 500% or more at room temperature. In this case, the strength of the base material 60a is preferably 1.0 N/mm or more at 80° C. Therefore, the waterproof member becomes less likely to break.

The adhesive layer 60b is an impregnation or film adhesive layer, and is preferably an impregnation adhesive layer. A thickness of the adhesive layer 60b is preferably 70 to 120 μm, and the waterproof performance of the skin material 20 can be satisfactorily enhanced. A viscosity of the adhesive layer 60b at 130° C. is preferably 0 to 149 Pa·S, and more preferably 20 to 40 Pa·S. Therefore, the back surface material 20b (base fabric) of the skin material 20 is easily impregnated with the adhesive layer 60b.

Incidentally, it is preferable that a method for attaching the waterproof member 60 (waterproof tape) is performed using, for example, a pressing device. Specifically, it is preferable that hot air is applied to the waterproof member 60 to melt the adhesive layer 60b of the waterproof member 60 and the waterproof member 60 is pressed onto the back surface material 20b of the skin material 20.

As shown in FIG. 3, the waterproof member 60 includes a waterproof body portion 61 that comes into contact with a back surface of the skin connecting portion 22; a first end portion 62 that is provided at one end portion of the waterproof member 60 in a width direction, and that comes into contact with a back surface of the first skin material 30; and a second end portion 63 that is provided at the other end portion of the waterproof member 60 in the width direction, and that comes into contact with a back surface of the second skin material 40.

In addition, the waterproof member 60 includes the first impregnated portion 64 with which a back surface material 30b of the first skin material 30 is impregnated; the second impregnated portion 65 with which a back surface material 40b of the second skin material 40 is impregnated; and the third impregnated portion 66 with which a back surface material of the skin connecting portion 22 (first skin connecting portion 32) is impregnated, and which is formed continuously with the first impregnated portion 64 and the second impregnated portion 65.

The impregnated portions 64, 65, and 66 are portions with which the back surface material 20b (30b and 40b) is impregnated by pressing the waterproof member 60 (adhesive layer 60b) onto the back surface of the skin material 20 (the first skin material 30 and the second skin material 40). The impregnated portion is also referred to as an impregnated adhesive portion or an impregnated adhesive layer.

It is preferable that the entirety of the back surface material 20b is impregnated with the impregnated portions 64, 65, and 66 in the thickness direction of the skin material 20 (back surface material 20b) and the impregnation is performed such that the impregnated portions 64, 65, and 66 reach the back surface of the front surface material 20a. Alternatively, it is preferable that at least a part of the impregnated portions 64, 65, and 66 reaches the back surface of the front surface material 20a. A part of the impregnated portions 64, 65, and 66 may reach the front surface material 20a, and a part of the front surface material 20a may be impregnated therewith.

The waterproof member 60 is attached in close contact with the first skin material 30 by the first impregnated portion 64, and is attached in close contact with the second skin material 40 by the second impregnated portion 65.

The first impregnated portion 64 and the second impregnated portion 65 are disposed at positions where the skin connecting portion 22 is sandwiched therebetween. The third impregnated portion 66 covers the entire back surface of the skin connecting portion 22, and is attached in close contact with the skin connecting portion 22.

Namely, the impregnated portions 64, 65, and 66 are disposed to surround the skin connecting portion 22.

As described above, by affixing (welding) the waterproof member 60 having a sheet shape to an overlapping portion (seam) of the first skin material 30 and the second skin material 40, the inside of the back surface materials 30b and 40b can be impregnated with the adhesive layer 60b, and the entry of water into a pad material 10 side can be suppressed.

In more detail, by impregnating the inside of the back surface materials 30b and 40b with the adhesive layer 60b, water entering through a gap between the first skin material 30 and the second skin material 40 and leaking onto the pad material 10 can be suppressed. In addition, water entering through the stitching portion 50 due to capillary action, traveling through the back surface materials 30b and 40b, and leaking onto the pad material 10 can be suppressed.

When the back surface materials 30b and 40b are impregnated with the adhesive layer 60b, the strength of bonding between the back surface materials 30b and 40b and the adhesive layer 60b is increased due to the anchor effect. In addition, the strength of bonding of the skin connecting portion 22 is also increased. Therefore, the width or length of the waterproof member 60 having a sheet shape can be made as small as possible. In addition, the diameter of the stitching portion 50 (diameter of the thread) can be reduced.

In the above-described configuration, as shown in FIG. 3, it is preferable that the first impregnated portion 64 is formed at least at a boundary portion B1 between the waterproof body portion 61 and the first end portion 62. In addition, it is preferable that the second impregnated portion 65 is formed at least at a boundary portion B2 between the waterproof body portion 61 and the second end portion 63.

Therefore, water that has entered from the skin connecting portion 22 at the boundary portions B1 and B2 can be stopped. Namely, the leakage of water, which has entered from the skin connecting portion 22, onto the pad material 10 can be suitably suppressed.

In the above-described configuration, as shown in FIG. 3, the second impregnated portion 65 passes through the back surface material 40b of the folded second skin material 40, and extends further from the boundary portion B2 between the waterproof body portion 61 and the second end portion 63 toward the stitching portion 50 (second stitching portion 52).

Therefore, water entering from the skin connecting portion 22 through the stitching portion 50, traveling through the back surface material 40b, and leaking onto the pad material 10 can be suitably suppressed.

In the above-described configuration, as shown in FIG. 3, the first impregnated portion 64, the second impregnated portion 65, and the third impregnated portion 66 extend continuously along the stitching portion 50 (stitching line 53). Namely, the impregnated portions 64, 65, and 66 are connected and extend linearly.

Therefore, water that has entered through the stitching portion 50 can be suitably stopped.

In the above-described configuration, as shown in FIG. 3, the first end portion 62 of the waterproof member 60 comes into contact with the front surface of the pad material 10. The second end portion 63 comes into contact with a portion of the front surface of the pad material 10 opposite to a first end portion 62 side with respect to the pad recess 13.

Therefore, the waterproof member 60 can be suitably attached in a state where the waterproof member 60 is sandwiched between the pad material 10 and the skin material 20.

In the above-described configuration, as shown in FIG. 4, at least a part of the skin connecting portion 22 is disposed at a position overlapping the through-holes 5 of the bottom plate 1 when the conveyance seat S1 is viewed from above.

Therefore, a load from a seated occupant can be released (dispersed) through the through-holes 5, and the load applied to the waterproof member 60 can be reduced. As a result, the deterioration of the waterproof member 60 can be suppressed.

In the above-described configuration, it is preferable that the waterproof member 60 is, for example, a black waterproof tape or a waterproof tape of the same color as the skin material 20.

Therefore, conventionally, a bias tape (tape that covers a gap) is affixed to prevent the pad material 10 from being exposed from a gap (seam) of the skin connecting portion 22; however, the need for the bias tape can be eliminated. Namely, by employing the waterproof member 60 having the above-described color, a reduction in the number of components (a reduction in cost) and a reduction in the weight of the conveyance skin material 20 can be achieved without impairing the appearance of the skin material 20.

In the conveyance seat S1 and the conveyance skin material 20, waterproof performance can be enhanced compared to the conventional art.

Specifically, even when the waterproof member 60 (waterproof tape) is attached to the skin connecting portion 22 of the skin material 20 (the first skin material 30 and the second skin material 40), the entry of water through the gap of the skin connecting portion 22 and the leakage of water onto the pad material 10 through the back surface material 20b (base fabric) can be suppressed.

### Conveyance Seats of Second Embodiment and Third Embodiment

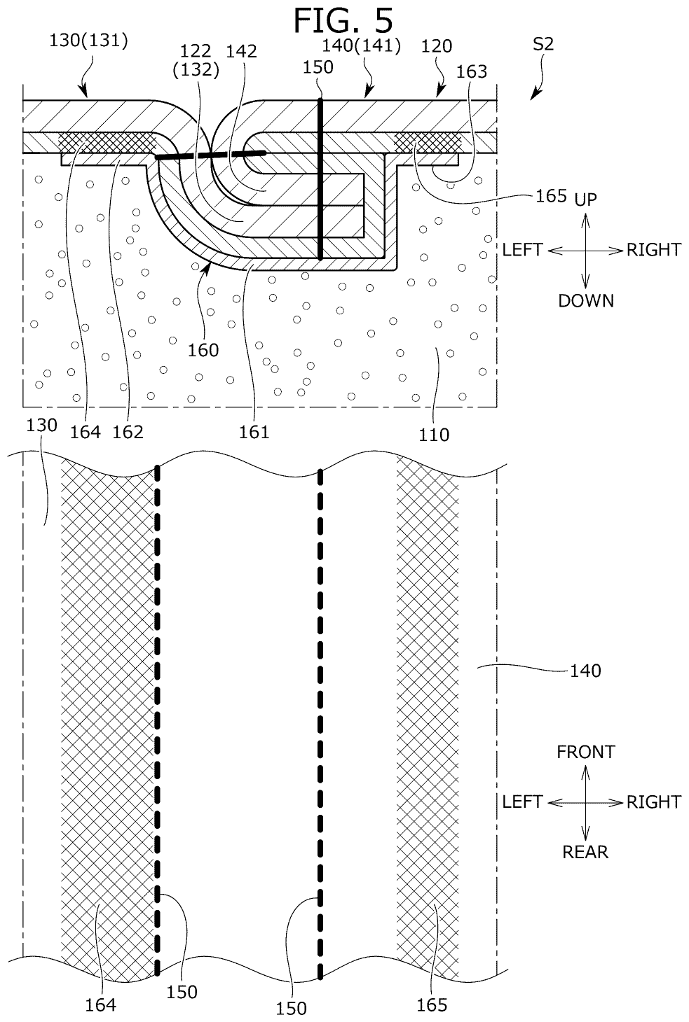

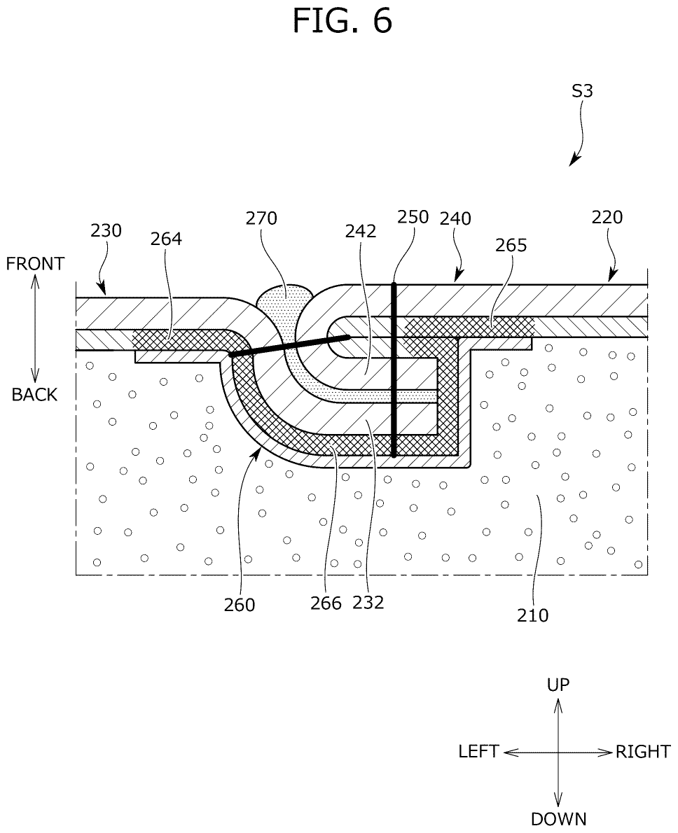

Next, conveyance seats S2 and S3 of a second embodiment and a third embodiment will be described with reference to FIGS. 5 and 6.

Incidentally, the description of contents that overlap with those of the conveyance seat S1 described above will be omitted.

As shown in FIG. 5, the conveyance seat S2 includes a pad material 110, a skin material 120 (a first skin material 130 and a second skin material 140), a stitching portion 150, and a waterproof member 160.

The first skin material 130 includes a first skin body 131 and a first skin connecting portion 132. The second skin material 140 includes a second skin body 141 and a second skin connecting portion 142.

The first skin connecting portion 132 and the second skin connecting portion 142 are folded toward a second skin material 140 side on a back surface side of the skin material 120. The first skin connecting portion 132 is disposed closer to the back surface side than the second skin connecting portion 142 in a thickness direction of the skin material 120.

The waterproof member 160 extends over a long length along a skin connecting portion 122, and is attached to cover the skin connecting portion 122 from the back surface side.

The waterproof member 160 includes a waterproof body portion 161, a first end portion 162, and a second end portion 163.

In addition, the waterproof member 160 includes a first impregnated portion 164 and a second impregnated portion 165.

The first impregnated portion 164 and the second impregnated portion 165 are disposed at positions where the skin connecting portion 122 is sandwiched therebetween.

The first impregnated portion 164 is formed in the first end portion 162 and the boundary portion B1 between the waterproof body portion 161 and the first end portion 162.

The second impregnated portion 165 is formed in the second end portion 163 and the boundary portion B2 between the waterproof body portion 161 and the second end portion 163.

Incidentally, the first impregnated portion 164 may be formed only in the first end portion 162, or may be formed only in the boundary portion B1. Similarly, the second impregnated portion 165 may be formed only in the second end portion 163, or may be formed only in the boundary portion B2.

As shown in FIG. 6, the conveyance seat S3 includes a pad material 210, a skin material 220 (a first skin material 230 and a second skin material 240), a stitching portion 250, a waterproof member 260, and a decorative member 270.

The decorative member 270 is a three-dimensional member that is attached to the skin material 220 to be exposed on a front surface of the seat S3, and is, for example, a bead.

The decorative member 270 is formed from a resin material, and is formed from, for example, a water-resistant and elastic resin material (rubber material).

The decorative member 270 is attached between a first skin connecting portion 232 of the first skin material 230 and a second skin connecting portion 242 of the second skin material 240.

With the above-described configuration, the decorative member 270 can be stably attached.

The waterproof member 260 includes a first impregnated portion 264, a second impregnated portion 265, and a third impregnated portion 266. As shown in FIG. 6, a part of the third impregnated portion 266 is provided at a position facing an end portion of the decorative member 270.

With the above-described configuration, water that has entered through a gap between the first skin material 230 (second skin material 240) and the decorative member 270 can be suitably stopped by the third impregnated portion 266.

In the conveyance seats S2 and S3 and the conveyance skin materials 120 and 220 as well, waterproof performance can be enhanced compared to the conventional art.

### Conveyance Seats of Fourth Embodiment and Fifth Embodiment

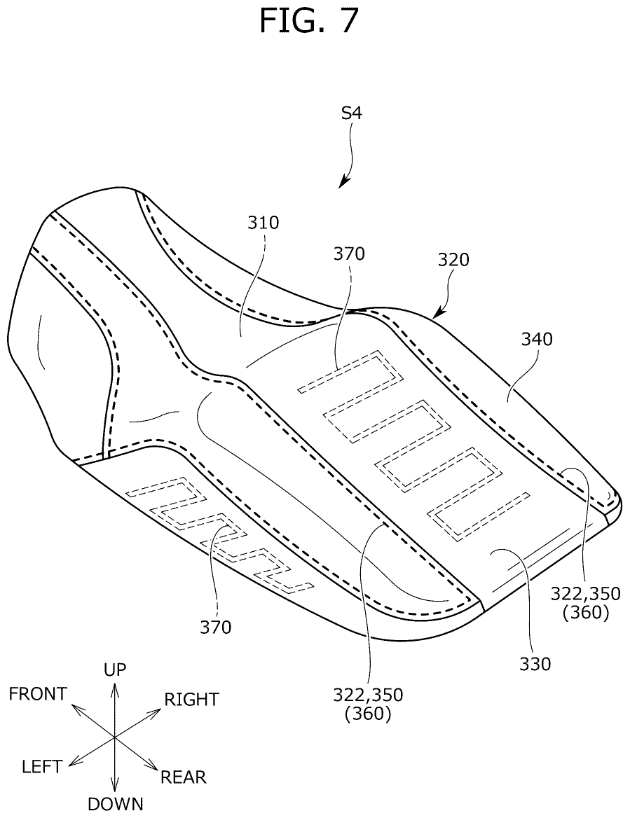

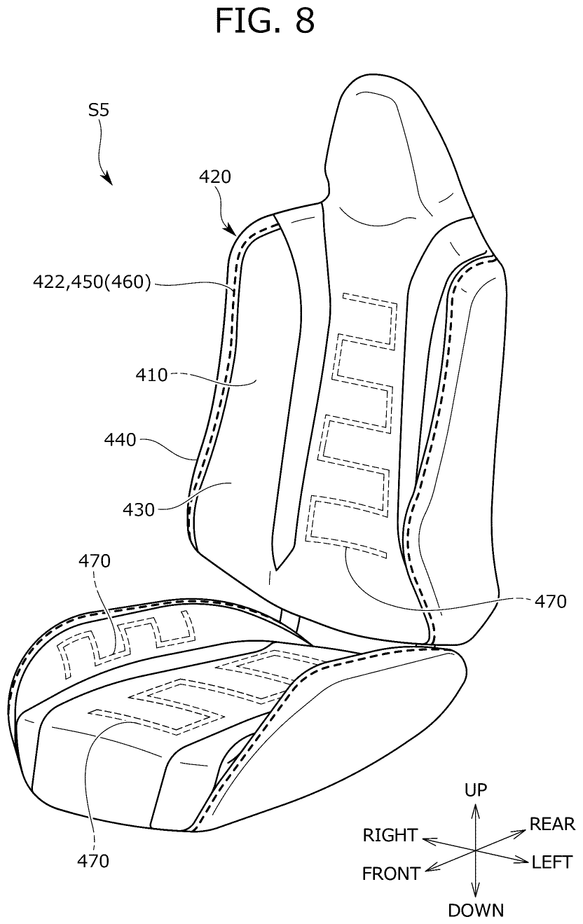

Next, conveyance seats S4 and S5 of a fourth embodiment and a fifth embodiment will be described with reference to FIGS. 7 and 8.

Incidentally, the description of contents that overlap with those of the conveyance seats S1 to S3 described above will be omitted.

As shown in FIG. 7, the conveyance seat S4 is a motorized two-wheeled vehicle seat, and includes a pad material 310, a skin material 320 (a first skin material 330 and a second skin material 340), a stitching portion 350, a waterproof member 360, and a seat heater 370.

The seat heater 370 is a planar heating element that warms the seat S4, is attached inside the seat S4, and is disposed between the pad material 310 and the skin material 320. The seat heater 370 is attached to a back surface of the skin material 320.

The seat heater 370 is disposed on the front surface of the skin material 320 at a position different from that of a skin connecting portion 322 (stitching portion 350). Namely, the seat heater 370 is disposed at a position different from that of the waterproof member 360 attached to a back surface of the skin connecting portion 322.

With the above-described configuration, the influence of heat of the seat heater 370 on impregnated portions of the waterproof member 360 can be suppressed. For example, a decrease in the adhesive strength of the waterproof member 360 can be suppressed.

As shown in FIG. 8, the conveyance seat S5 is a seat that is used outdoors in an all-terrain vehicle (buggy) or the like.

The conveyance seat S5 includes a pad material 410, a skin material 420 (a first skin material 430 and a second skin material 440), a stitching portion 450, a waterproof member 460, and a seat heater 470.

The seat heater 470 is disposed on the front surface of the skin material 420 at a position different from that of a skin connecting portion 422 (stitching portion 450). Namely, the seat heater 470 is disposed at a position different from that of the waterproof member 460 attached to a back surface of the skin connecting portion 422.

In the conveyance seats S4 and S5 and the conveyance skin materials 320 and 420, waterproof performance can be enhanced compared to the conventional art.

### Method for Manufacturing Conveyance Seat and Conveyance Skin Material

Next, a method for manufacturing the conveyance seat S1 will be described with reference to FIGS. 1 to 4.

Incidentally, regarding the method for manufacturing the conveyance seat S1, the description of manufacturing steps other than those to be described below will be omitted.

First, the bottom plate 1 is prepared, and the pad material 10 is disposed on the bottom plate 1. Then, the bottom plate 1 and the pad material 10 are covered with the skin material 20.

In the step of covering with the skin material 20, the second skin material 40 is attached to the first skin material 30 in a state where the second skin material 40 partially overlaps the first skin material 30 (stitched together by the stitching portion 50). Then, the skin connecting portion 22 (the first skin connecting portion 32 and the second skin connecting portion 42) is folded toward the second skin material 40 side on the back surface of the skin material 20. Then, the waterproof member 60 is attached to cover the skin connecting portion 22 from the back surface side.

In this case, the waterproof member 60 is provided to cover the first skin connecting portion 32 and the second skin connecting portion 42.

In addition, the first end portion 62 of the waterproof member 60 is attached to the back surface of the first skin material 30, and the second end portion 63 is attached to the back surface of the second skin material 40.

Specifically, the back surface material 30b of the first skin material 30 is impregnated with the adhesive layer 60b of the waterproof member 60, so that the first impregnated portion 64 is formed. In addition, the back surface material 40b of the second skin material 40 is impregnated with the adhesive layer 60b, so that the second impregnated portion 65 is formed. Then, the waterproof member 60 is attached to the first skin material 30 and the second skin material 40 by the impregnated portions 64 and 65.

The first impregnated portion 64 and the second impregnated portion 65 are disposed at positions where the skin connecting portion 22 is sandwiched therebetween.

### Others

In the above-described embodiment, as shown in FIG. 2, the conveyance seat S1 includes the bottom plate 1 serving as a base substrate, but is not particularly limited.

For example, the conveyance seat S1 may include a seat frame serving as a skeleton of the seat, instead of the bottom plate 1. Alternatively, the bottom plate 1 may not be provided.

In the above-described embodiment, as shown in FIG. 1, the conveyance skin material 20 is used for the conveyance seat S1, but is not particularly limited.

For example, the conveyance skin material 20 may be used for conveyance interior components or the like. Preferably, the conveyance skin material 20 is used for conveyance interior components that are directly exposed to wind and rain or snow.

In addition, for example, the skin material 20 may be used for two-wheeled vehicle handlebar covers, mountaineering gloves, two-wheeled vehicle side bags, jackets, shoes, and the like, or may be used as a urethane sealing material for a headrest molded by skin-integrated foaming. Incidentally, when urethane is injected into a skin material, it is preferable that a waterproof member is used to prevent the urethane material from seeping out through sewing holes of the skin material.

In the above-described embodiment, as shown in FIG. 3, the first skin material 30 and the second skin material 40 are connected to each other in a state where the first skin material 30 and the second skin material 40 are partially overlapped; however, the skin materials may not overlap each other.

For example, a skin terminal of the first skin material 30 and a skin terminal of the second skin material 40 may be stitched together by the stitching portion in a state where the skin terminals are folded to opposite sides (the skins may not overlap each other).

In the above-described embodiment, as shown in FIG. 3, the waterproof member 60 having a sheet shape is attached to cover the skin connecting portion 22 from the back surface side; however, the attachment position of the waterproof member 60 is not particularly limited.

For example, when a decorative stitching portion (stitching line) is applied to a part of a skin material, the waterproof member 60 may be attached to the stitching portion to ensure waterproof performance.

Even in that case, it is preferable that at least both end portions of the waterproof member have impregnated portions.

In the above-described embodiment, the motorized two-wheeled vehicle seat that is directly exposed to sunlight or directly exposed to wind and rain or snow has been described as a specific example; however, the present invention is not particularly limited, and can be used in saddle-type conveyance seats that are used outdoors, for example, in snow bikes, water bikes, all-terrain vehicles (buggies), and the like.

In addition, the above-described conveyance seats can be used not only as saddle-type conveyance seats, but also as vehicle seats for automobiles, trains, and buses and conveyance seats for airplanes and ships.

### Conveyance Seat of Sixth Embodiment

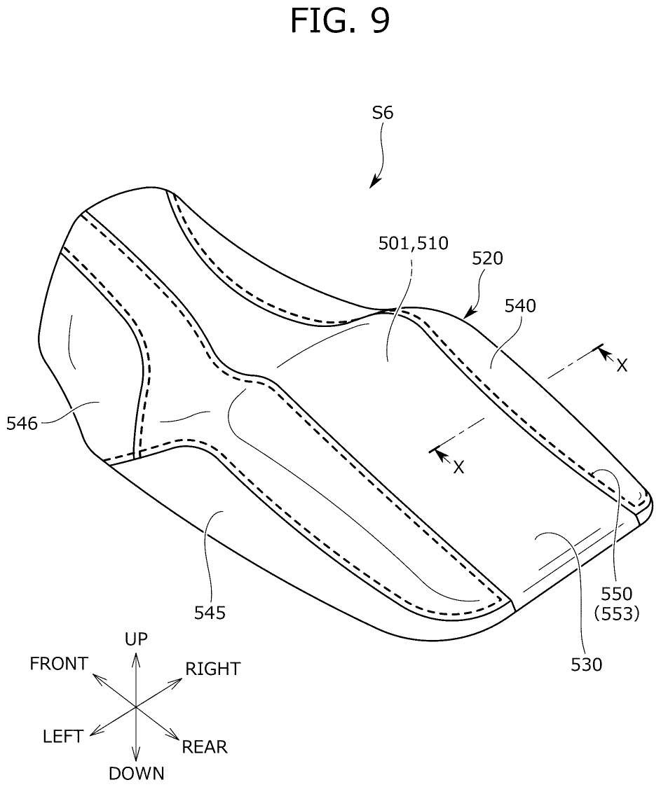

Next, a conveyance seat S6 of a sixth embodiment will be described with reference to FIGS. 9 to 12.

Incidentally, the description of contents that overlap with those of the conveyance seats S1 to S5 described above will be omitted.

The conveyance seat S6 realizes a seat capable of suppressing the influence on the finish even when a waterproof member having a sheet shape is attached.

As shown in FIGS. 9 to 12, the conveyance seat S6 is a seat constituting a seating portion of a motorized two-wheeled vehicle, and is a saddle-type seat that is directly exposed to sunlight or directly exposed to wind and rain or snow. Hereinafter, the conveyance seat S6 will also be referred to simply as the seat S6.

The conveyance seat S6 includes a bottom plate 501 attached onto a vehicle body and serving as a base substrate; a pad material 510 placed on the bottom plate 501; a skin material 520 (a first skin material 530 and a second skin material 540) that covers the bottom plate 501 and the pad material 510; a stitching portion 550 that attaches the first skin material 530 and the second skin material 540 to each other in a state where the first skin material 530 and the second skin material 540 are partially overlapped; and a waterproof member 560 having a sheet shape and attached to a back surface of the skin material 520.

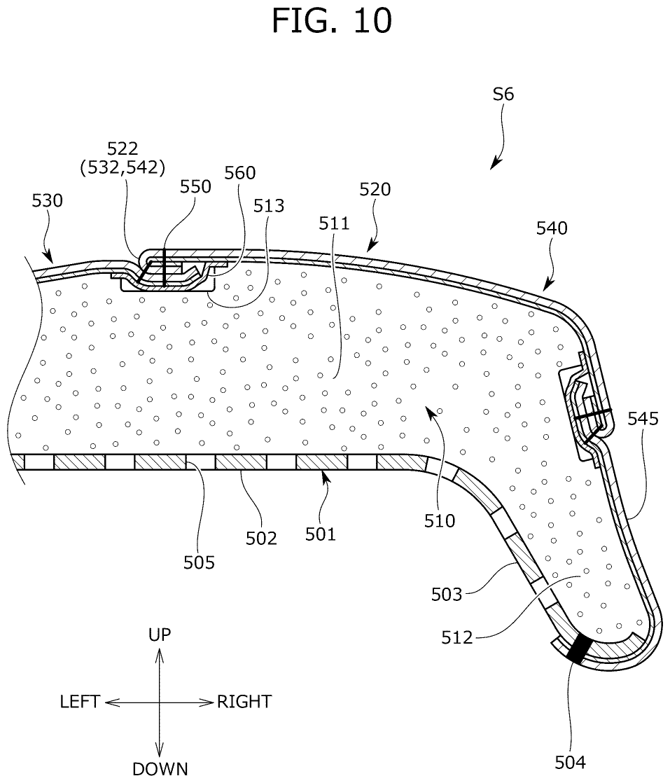

Incidentally, in the conveyance seat S6, as shown in FIG. 10, skin terminal treatment is performed by attaching a terminal portion of the skin material 520 to a back surface of the bottom plate 501. Specifically, an attaching member 504 such as a tacker needle is used for the skin terminal treatment.

As shown in FIG. 10, the bottom plate 501 is a plate that is long in a seat front to rear direction, and is a base substrate of the seat S6, which is formed in a curved shape to match the outer shape of the vehicle body.

Specifically, the bottom plate 501 is mainly composed of a plate body portion 502 serving as a body portion of the bottom plate 501, and a plate outer peripheral portion 503 serving as a flange portion formed by bending an outer peripheral portion of the plate body portion 502 diagonally downward.

The bottom plate 501 is formed as a synthetic resin-molded product using a resin material such as polypropylene or polyethylene as a raw material.

Incidentally, the bottom plate 501 is not limited to being formed from the above-described resin material, and may be formed from various materials. For example, a resin material having a relatively high bending modulus, such as glass fiber-reinforced polypropylene (GFPP), may be used as the raw material.

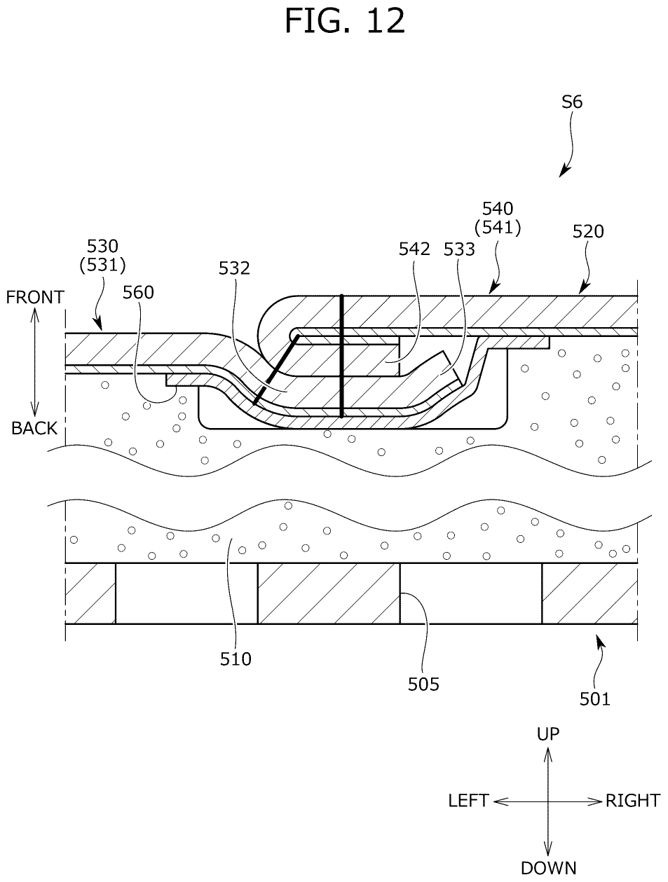

As shown in FIGS. 10 and 12, a plurality of through-holes 505 penetrating through the bottom plate 501 in an up to down direction are formed on a front surface of the bottom plate 501. Each of the through-holes 505 is a ventilation hole for ensuring the breathability of the seat S6, and is also referred to as an air release hole.

As shown in FIGS. 9 to 12, the pad material 510 is a cushion pad that is made of an elastic member such as urethane foam and that is long in the seat front to rear direction, and is formed to be slightly larger than the outer shape of the bottom plate 501.

Specifically, the pad material 510 includes a pad body portion 511 serving as a body portion of the pad material 510, and a pad projecting portion 512 projecting from an outer peripheral portion of the pad body portion 511, and extending along a front surface of the plate outer peripheral portion 503 of the bottom plate 501.

As shown in FIG. 10, the pad projecting portion 512 is provided to surround substantially the entire periphery of the bottom plate 501 from the outside.

A pad recess 513 recessed toward a back surface side of the pad material 510 is formed in a portion of a front surface of the pad material 510, the portion facing a skin overlapping portion 522 where the skin material 520 (the first skin material 530 and the second skin material 540) is overlapped.

The skin overlapping portion 522 is accommodated in the pad recess 513.

As shown in FIGS. 9 to 12, the skin material 520 is a covering material constituting the appearance of the seat S6, is made of a covering material such as polyvinyl chloride (PVC) leather, and is formed, for example, by bonding a soft polyvinyl chloride layer to a front surface of a fabric.

Specifically, the skin material 520 includes a front surface material 520a made of a covering material, and a back surface material 520b made of a fabric and bonded to a back surface of the front surface material 520a.

By employing polyvinyl chloride leather or the like as the material for the skin material 520 (front surface material 520a), the material is made suitable as a skin material for a motorized two-wheeled vehicle which is directly exposed to wind and rain.

In addition, by forming the front surface material 520a from a material that is relatively difficult to stretch, the attachment strength of the front surface material 520a can be ensured while ensuring the design of the front surface of the seat (while preventing wrinkles or looseness from occurring).

The skin material 520 includes the first skin material 530 constituting an upper surface of the seat S6; the second skin material 540 constituting the upper surface and side surfaces of the seat S6; a third skin material 545 constituting lower portions of the side surfaces and a bottom surface of the seat S6; and a fourth skin material 546 constituting both front side surfaces of the seat S6.

In other words, it can be said that the skin material 520 is mainly composed of a first skin piece (first skin material 530), a second skin piece (second skin material 540), a third skin piece (third skin material 545), and a fourth skin piece (fourth skin material 546).

Incidentally, the skin material 520 may be composed of two skin materials (the first skin material 530 and the second skin material 540), or may be composed of three or more skin materials.

The first skin material 530 includes a first skin body 531 serving as a body portion of the first skin material 530; a first skin overlapping portion 532 that is provided at an end portion of the first skin body 531, and that overlaps the second skin material 540; and a first skin terminal portion 533 extending further from the first skin overlapping portion 532.

The first skin terminal portion 533 may be referred to as an extension portion.

The second skin material 540 includes a second skin body 541 serving as a body portion of the second skin material 540, and a second skin overlapping portion 542 that is provided at an end portion of the second skin body 541, and that overlaps the first skin material 530.

The second skin overlapping portion 542 serves as a skin terminal portion of the second skin material 540. Namely, the second skin overlapping portion 542 may be referred to as a second skin terminal portion.

The third skin material 545 and the fourth skin material 546 have the same configuration. Specifically, as shown in FIG. 9, the third skin material 545 and the fourth skin material 546 are attached to the second skin material 540 in a state where the third skin material 545 and the fourth skin material 546 partially overlap the second skin material 540.

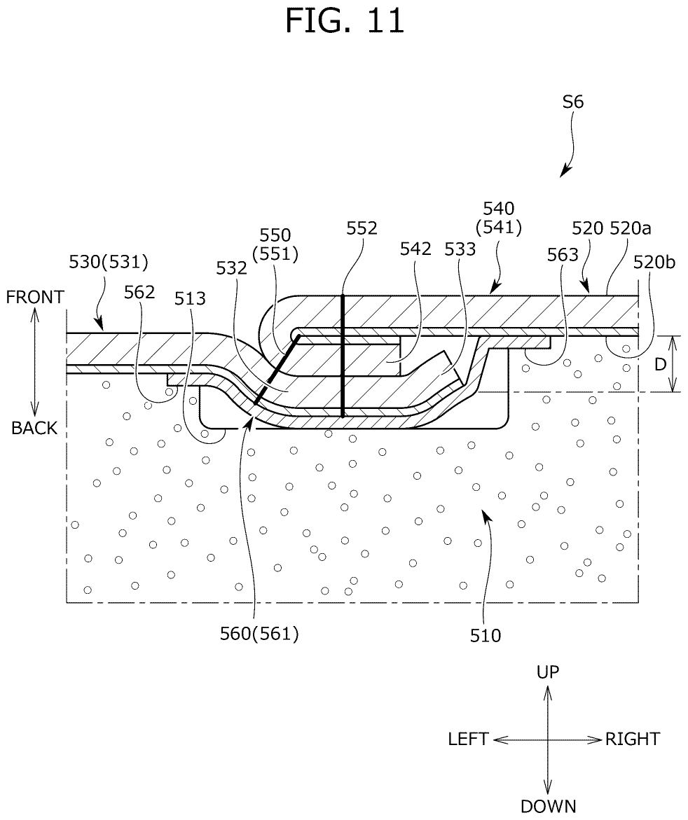

As shown in FIGS. 10 and 11, the first skin material 530 is attached to the second skin material 540 by the stitching portion 550 in a state where the first skin material 530 partially overlaps the second skin material 540.

Specifically, the skin overlapping portion 522 (the first skin overlapping portion 532 and the second skin overlapping portion 542) is folded toward a second skin material 540 side on a back surface side of the skin material 520. Furthermore, the first skin overlapping portion 532 and the second skin overlapping portion 542 are stitched together by a first stitching portion 551 and a second stitching portion 552.

The first skin overlapping portion 532 is disposed closer to the back surface side than the second skin overlapping portion 542 in a thickness direction of the skin material 520.

The first stitching portion 551 stitches together the first skin overlapping portion 532 and the second skin overlapping portion 542. The second stitching portion 552 stitches together the first skin overlapping portion 532, the second skin overlapping portion 542, and the second skin body 541.

Incidentally, as shown in FIG. 9, stitching lines 553 are formed on a front surface of the skin material 520 by stitching together the first skin material 530 and the second skin material 540.

As shown in FIGS. 10 to 12, the waterproof member 560 is, for example, a waterproof tape, extends over a long length along the skin overlapping portion 522 (the first skin overlapping portion 532 and the second skin overlapping portion 542) where the first skin material 530 and the second skin material 540 overlap each other, and is attached to cover the skin overlapping portion 522 from the back surface side.

The waterproof member 560 is formed from polyurethane resin or the like, and includes a base material having stretchability (water-resistant base material or waterproof base material), and an adhesive layer provided on the base material and having adhesive properties.

It is preferable that the waterproof member 560 includes a film or impregnation adhesive layer. Incidentally, in the case of an impregnation waterproof member, waterproof performance can be enhanced, but attachment marks (press marks or welding marks) are formed on the front surface of the skin material, which is a risk. However, in the skin material 520 of the present embodiment, since a step D between the body of the skin material 520 and the skin overlapping portion 522 in the thickness direction of the skin material 520 can be reduced, attachment marks are less likely to be formed.

Therefore, in the present embodiment, it is preferable that an impregnation waterproof member is used.

As shown in FIG. 11, the waterproof member 560 is affixed to cover the first skin overlapping portion 532, the second skin overlapping portion 542, and the first skin terminal portion 533.

Specifically, the waterproof member 560 (waterproof body portion 561) comes into contact with each of a back surface of the first skin overlapping portion 532 and a back surface of the first skin terminal portion 533, and is in close contact with each of the first skin overlapping portion 532 and the first skin terminal portion 533 to follow the first skin overlapping portion 532 and the first skin terminal portion 533.

Furthermore, one end portion 562 of the waterproof member 560 in a width direction is attached to a back surface of the first skin material 530 (first skin body 531), and the other end portion 563 of the waterproof member in the width direction is attached to a back surface of the second skin material 540 (second skin body 541).

By providing the waterproof member 560 as described above, water can be prevented from entering through a gap between the first skin material 530 and the second skin material 540 and leaking onto the pad material 510, and water can be prevented from entering through the stitching portion 550 and traveling through the back surface material 520b to leak onto the pad material 510.

Particularly, when the waterproof member 560 is attached to a back surface of the skin overlapping portion 522, a step is generated due to the skin overlapping portion 522; however, in the skin material 520 of the present embodiment, a design feature is implemented to reduce the step at the skin overlapping portion 522.

Specifically, the first skin material 530 includes the first skin overlapping portion 532 and the first skin terminal portion 533 (extension portion) extending further from the first skin overlapping portion 532. Furthermore, the waterproof member 560 is attached to cover the first skin overlapping portion 532, the second skin overlapping portion 542, and the first skin terminal portion 533. By extending the terminal portion of the first skin material 530 further from the skin overlapping portion 532 in such a manner, the step D formed between the body of the skin material 520 and the skin overlapping portion 522 in the thickness direction of the skin material 520 can be reduced. Namely, the step D is gently formed (the step D is divided into small segments) by the interposition of the first skin terminal portion 533 (extension portion). Therefore, when the waterproof member is welded, the welding area of the waterproof member to the skin material can be increased, and the pressure during welding can be made uniform (distributed). More specifically, by inclining the step portion of the waterproof member 560, the pressure applied from a lower end portion to an upper end portion can be distributed (the pressure difference can be reduced). As a result, the formation of attachment marks (press marks) on the front surface of the skin material can be suppressed.

Furthermore, by inclining (sloping) the conventional step having a difference in height as much as possible, pressure can be applied more uniformly when the waterproof member 560 is welded to the skin material 520. As a result, the finish of the skin material 520 can be improved.

Incidentally, it is preferable that a method for attaching the waterproof member 560 (waterproof tape) is performed using, for example, a pressing device. Specifically, it is preferable that hot air is applied to the waterproof member 560 to melt the adhesive layer of the waterproof member 560 and the waterproof member 560 is pressed onto the back surface material 520b of the skin material 520.

In the above-described configuration, as shown in FIG. 11, an extension length of the first skin terminal portion 533 is formed to be shorter than an extension length of the first skin overlapping portion 532. Therefore, an increase in cost due to an increase in the amount of use of the first skin material 530 can be suppressed by making the extension portion of the first skin material 530 as short as possible.

In addition, the first skin terminal portion 533 extends to approach the second skin material 540 side from an extension end portion of the first skin overlapping portion 532 in the thickness direction of the skin material 520. At least a part of the first skin terminal portion 533 is disposed at a position overlapping the second skin overlapping portion 542 in the thickness direction of the skin material 520. Therefore, an increase in the overall thickness of the skin material 520 can be suppressed.

In the above-described configuration, as shown in FIG. 11, the skin overlapping portion 522 (the first skin overlapping portion 532 and the second skin overlapping portion 542) and the first skin terminal portion 533 are accommodated in the pad recess 513 formed on the front surface of the pad material 510. Therefore, the lifting of the skin overlapping portion 522 of the skin material 520 can be suppressed, and the degradation of the design of the skin material 520 can be suppressed.

In addition, the one end portion 562 of the waterproof member 560 in the width direction comes into contact with the front surface of the pad material 510, and the other end portion 563 of the waterproof member 560 in the width direction comes into contact with a portion of the front surface of the pad material 510 opposite to one end portion side of the waterproof member 560 with respect to the pad recess 513. Therefore, the waterproof member 560 can be suitably attached in a state where the waterproof member 560 is sandwiched between the pad material 510 and the skin material 520.

In the above-described configuration, as shown in FIG. 12, the skin overlapping portion 522 is disposed at a position that does not overlap the through-holes 505 of the bottom plate 501 when the conveyance seat S6 is viewed from above. Therefore, the bottom plate 501 can provide a suitable support at the skin overlapping portion 522 where a load from a seated occupant is relatively likely to be applied.

In addition, the first skin terminal portion 533 is disposed at a position overlapping the through-holes 505 of the bottom plate 501 when the conveyance seat S6 is viewed from above. Therefore, breathability provided by the through-holes 505 can be enhanced while ensuring the durability of the conveyance seat S6. In addition, a reduction in weight can also be achieved by the through-holes 505.

In the conveyance seat and the conveyance skin material described above, even when the waterproof member having a sheet shape is attached, the influence on the finish can be suppressed.

### Conveyance Seat of Seventh Embodiment

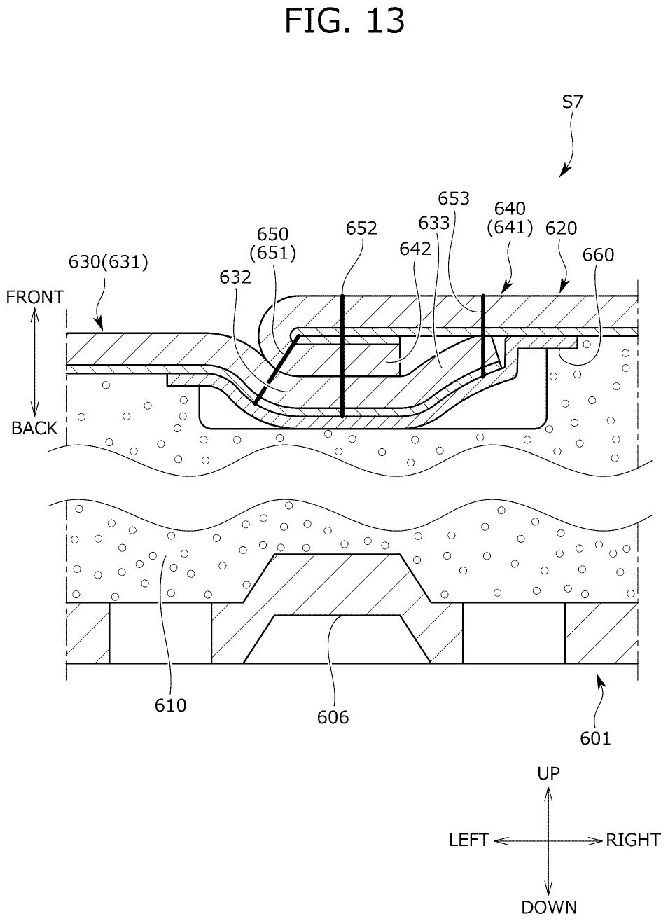

Next, a conveyance seat S7 of a seventh embodiment will be described with reference to FIG. 13.

Incidentally, the description of contents that overlap with those of the conveyance seats S1 to S6 described above will be omitted.

The conveyance seat S7 realizes a seat capable of suppressing the influence on the finish even when a waterproof member having a sheet shape is attached.

The conveyance seat S7 includes a bottom plate 601, a pad material 610, a skin material 620 (a first skin material 630 and a second skin material 640), a stitching portion 650, and a waterproof member 660.

The first skin material 630 includes a first skin body 631, a first skin overlapping portion 632, and a first skin terminal portion 633.

The second skin material 640 includes a second skin body 641 and a second skin overlapping portion 642.

The first skin overlapping portion 632 and the second skin overlapping portion 642 are folded toward a second skin material 640 side on a back surface side of the skin material 620. Furthermore, the first skin overlapping portion 632 and the second skin overlapping portion 642 are stitched together by a first stitching portion 651, a second stitching portion 652, and a third stitching portion 653.

The first skin overlapping portion 632 is disposed closer to the back surface side than the second skin overlapping portion 642 in a thickness direction of the skin material 620.

The third stitching portion 653 stitches together the first skin terminal portion 633 and the second skin body 641.

The first skin terminal portion 633 is no longer a free end, but is fixed to the second skin material 640 by the third stitching portion 653.

Therefore, the work of attaching the waterproof member 660 to the first skin overlapping portion 632 and the first skin terminal portion 633 becomes facilitated, and the attachment strength can be increased.

In the above-described configuration, as shown in FIG. 13, a reinforcing recess 606 recessed toward a front surface side of the bottom plate 601 is formed on a front surface of the bottom plate 601. The first skin overlapping portion 632 (second skin overlapping portion 642) is disposed at a position overlapping the reinforcing recess 606 when the seat S7 is viewed from above. Therefore, the bottom plate 601 (reinforcing recess 606) can provide a suitable support at the first skin overlapping portion 632 where a load from a seated occupant is relatively likely to be applied.

In addition, the first skin terminal portion 633 is disposed at a position that does not overlap the reinforcing recess 606 when the seat S7 is viewed from above. Therefore, the reinforcing recess 606 can be disposed at a position that does not correspond to the first skin terminal portion 633 (extension portion) where the load from the seated occupant is relatively less likely to be applied.

### Conveyance Seat of Eighth Embodiment

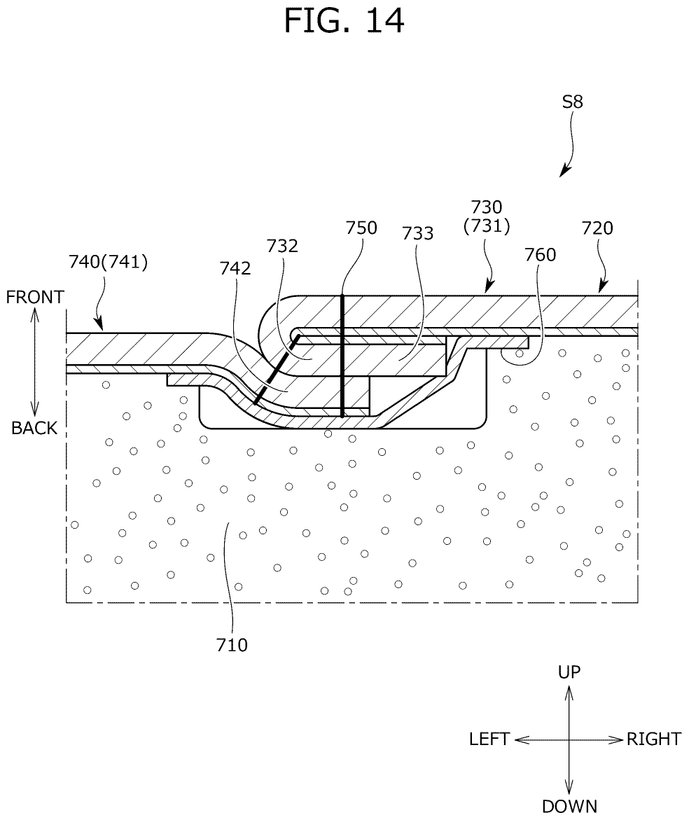

Next, a conveyance seat S8 of an eighth embodiment will be described with reference to FIG. 14.

Incidentally, the description of contents that overlap with those of the conveyance seats S1 to S7 described above will be omitted.

The conveyance seat S8 realizes a seat capable of suppressing the influence on the finish even when a waterproof member having a sheet shape is attached.

The conveyance seat S8 includes a pad material 710, a skin material 720 (a first skin material 730 and a second skin material 740), a stitching portion 750, and a waterproof member 760.

The first skin material 730 includes a first skin body 731, a first skin overlapping portion 732, and a first skin terminal portion 733.

The second skin material 740 includes a second skin body 741 and a second skin overlapping portion 742.

The first skin overlapping portion 732 and the second skin overlapping portion 742 are folded toward a first skin material 730 side on a back surface side of the skin material 720. Furthermore, the first skin overlapping portion 732 and the second skin overlapping portion 742 are stitched together by the stitching portion 750.

The second skin overlapping portion 742 is disposed closer to the back surface side than the first skin overlapping portion 732 in a thickness direction of the skin material 720.

The waterproof member 760 comes into contact with each of a back surface of the second skin overlapping portion 742 and a back surface of the first skin terminal portion 733, and is attached to follow each of the second skin overlapping portion 742 and the first skin terminal portion 733.

Furthermore, a right end portion of the waterproof member 760 is attached to a back surface of the first skin material 730, and a left end portion of the waterproof member is attached to a back surface of the second skin material 740.

### Conveyance Seat of Ninth Embodiment

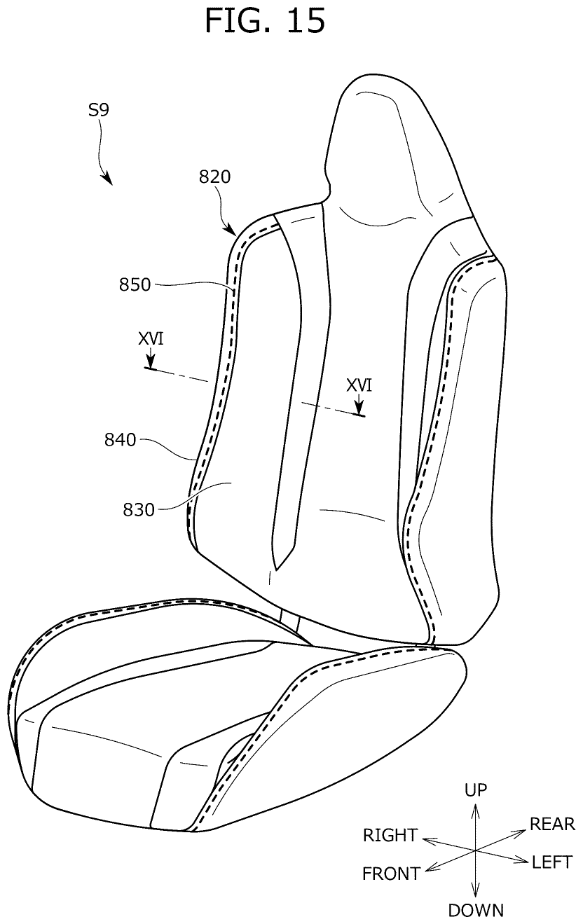

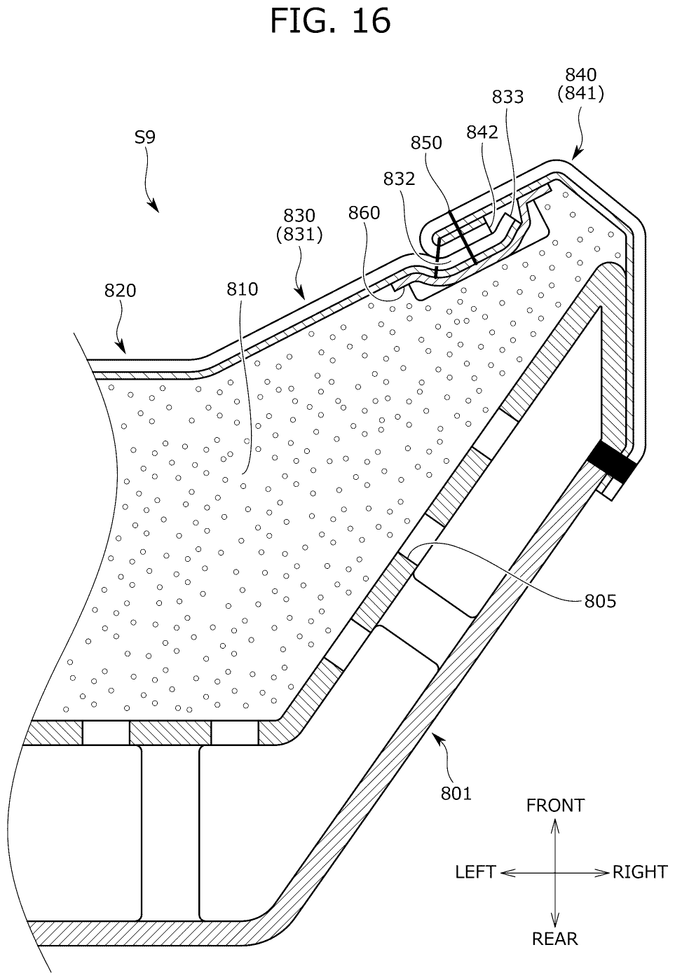

Next, a conveyance seat S9 of a ninth embodiment will be described with reference to FIGS. 15 and 16.

Incidentally, the description of contents that overlap with those of the conveyance seats S1 to S8 described above will be omitted.

The conveyance seat S9 realizes a seat capable of suppressing the influence on the finish even when a waterproof member having a sheet shape is attached.

The conveyance seat S9 is a seat that is used outdoors in an all-terrain vehicle (buggy) or the like.

The conveyance seat S9 includes a bottom plate 801, a pad material 810, a skin material 820 (a first skin material 830 and a second skin material 840), a stitching portion 850, and a waterproof member 860.

The first skin material 830 includes a first skin body 831, a first skin overlapping portion 832, and a first skin terminal portion 833.

The second skin material 840 includes a second skin body 841 and a second skin overlapping portion 842.

The first skin overlapping portion 832 and the second skin overlapping portion 842 are disposed at positions that do not overlap through-holes 805 of the bottom plate 801.

The waterproof member 860 adheres to cover the first skin overlapping portion 832, the second skin overlapping portion 842, and the first skin terminal portion 833.

Specifically, the waterproof member 860 is in close contact with each of the first skin overlapping portion 832 and the first skin terminal portion 833 to follow the first skin overlapping portion 832 and the first skin terminal portion 833.

### Method for Manufacturing Conveyance Seat and Conveyance Skin Material

Next, a method for manufacturing the conveyance seat S6 will be described with reference to FIGS. 9 to 11.

Incidentally, regarding the method for manufacturing the conveyance seat S6, the description of manufacturing steps other than those to be described below will be omitted.

First, the bottom plate 501 is prepared, and the pad material 510 is disposed on the bottom plate 501. Then, the bottom plate 501 and the pad material 510 are covered with the skin material 520.

In the step of covering with the skin material 520, the second skin material 540 is attached to the first skin material 530 in a state where the second skin material 540 partially overlaps the first skin material 530 (stitched together by the stitching portion 550). Then, the skin overlapping portion 522 (the first skin overlapping portion 532 and the second skin overlapping portion 542) is folded toward the second skin material 540 side on the back surface of the skin material 520. Then, the waterproof member 560 is attached to cover the skin overlapping portion 522 from the back surface side.

In this case, it is preferable that the waterproof member 560 is provided to cover the first skin overlapping portion 532, the second skin overlapping portion 542, and the first skin terminal portion 533.

In addition, the one end portion of the waterproof member 560 in the width direction is attached to the back surface of the first skin material 530, and the other end portion of the waterproof member 560 in the width direction is attached to the back surface of the second skin material 540.

### Supplementary Notes on Conveyance Seats of Sixth to Ninth Embodiments

It is preferable that the conveyance skin material described above is a conveyance skin material that is used for a conveyance, comprising: a first skin material; a second skin material attached in a state where the second skin material partially overlaps the first skin material; and a waterproof member having a sheet shape, extending along a skin overlapping portion where the first skin material and the second skin material overlap each other, and attached to cover the skin overlapping portion from a back surface side of the conveyance skin material. It is preferable that the skin overlapping portion is folded toward a first skin material side or a second skin material side and is disposed on the back surface side of the conveyance skin material. It is preferable that the first skin material includes a first skin overlapping portion overlapping a second skin terminal portion of the second skin material, and a first skin terminal portion extending further from the first skin overlapping portion. It is preferable that the second skin material is configured such that the second skin terminal portion overlaps the first skin overlapping portion, as a second overlapping portion. It is preferable that the waterproof member is provided to cover the skin overlapping portion including the first skin overlapping portion and the second skin overlapping portion, and the first skin terminal portion. It is preferable that one end portion of the waterproof member in a width direction is attached to a back surface of the first skin material and the other end portion of the waterproof member in the width direction is attached to a back surface of the second skin material.

With the above-described configuration, even when the waterproof member having a sheet shape is attached, the conveyance skin material capable of suppressing the influence on the finish can be realized.

In detail, when the waterproof member is attached to a back surface of the skin overlapping portion, a step is generated due to the skin overlapping portion; however, in the conveyance skin material described above, a design feature is implemented to reduce the step at the skin overlapping portion. Specifically, the first skin material includes the first skin overlapping portion overlapping the second skin terminal portion, and the first skin terminal portion extending further from the first skin overlapping portion. Furthermore, the waterproof member is attached to cover the skin overlapping portion including the first skin overlapping portion and the second skin overlapping portion, and the first skin terminal portion. By extending the terminal portion of the first skin material further from the skin overlapping portion in such a manner, the step formed between the body of the skin material and the skin overlapping portion in a thickness direction of the skin material can be reduced. Namely, the step is gently formed (the step is divided into small segments) by the interposition of the first skin terminal portion (extension portion). Therefore, when the waterproof member is attached, the attachment area (adhesion area) of the waterproof member to the skin material can be increased, and the pressure can be made uniform (pressure is distributed). As a result, the formation of attachment marks (press marks) on a front surface of the skin material can be suppressed.

In this case, it is preferable that the first skin overlapping portion is disposed closer to the back surface side than the second skin overlapping portion in a thickness direction of the conveyance skin material. It is preferable that the waterproof member comes into contact with a back surface of the first skin overlapping portion and a back surface of the first skin terminal portion, and is attached to follow each of the first skin overlapping portion and the first skin terminal portion.

As described above, since the waterproof member comes into contact with each of the back surface of the first skin overlapping portion and the back surface of the first skin terminal portion, and is attached to follow each of the first skin overlapping portion and the first skin terminal portion, the waterproof member can be suitably attached in close contact with a back surface of the skin material. In addition, the finish of the skin material can be improved.

In this case, it is preferable that an extension length of the first skin terminal portion is formed to be shorter than an extension length of the first skin overlapping portion. It is preferable that the first skin terminal portion is disposed to approach the second skin material side from an extension end portion of the first skin overlapping portion in a thickness direction of the conveyance skin material. It is preferable that at least a part of the first skin terminal portion is disposed at a position overlapping the second skin terminal portion in the thickness direction of the conveyance skin material.

As described above, since the extension length of the first skin terminal portion is formed to be shorter than the extension length of the first skin overlapping portion, the extension portion of the skin material is made as short as possible, so that an increase in cost due to an increase in the amount of use of the skin material is suppressed.

In addition, as described above, since at least a part of the first skin terminal portion is disposed at a position overlapping the second skin terminal portion in the thickness direction of the conveyance skin, an increase in the thickness of the skin material can be suppressed.

In this case, it is preferable that the first skin overlapping portion is attached to the second skin overlapping portion by sewing. It is preferable that the first skin terminal portion is disposed at a position facing the second skin material in a thickness direction of the conveyance skin material, and is attached to the second skin material by sewing.

With the above-described configuration, the first skin terminal portion is no longer a free end, but is fixed to the second skin material by sewing. Therefore, the work of attaching the waterproof member to the skin overlapping portion and the first skin terminal portion becomes facilitated, and the attachment strength can be increased.

In this case, it is preferable that a conveyance seat includes the conveyance skin material described above; and a pad material covered with the conveyance skin material. It is preferable that the skin overlapping portion and the first skin terminal portion are accommodated in a pad recess formed on a front surface of the pad material.

With the above-described configuration, the lifting of the skin overlapping portion of the skin material can be suppressed, and the degradation of the design of the skin material can be suppressed.

In this case, it is preferable that the one end portion of the waterproof member in the width direction comes into contact with the front surface of the pad material, and the other end portion of the waterproof member in the width direction comes into contact with a portion of the front surface of the pad material opposite to one end portion side of the waterproof member with respect to the pad recess.

With the above-described configuration, the waterproof member can be suitably attached in a state where the waterproof member is sandwiched between the pad material and the skin material.

In this case, it is preferable that a bottom plate, the pad material disposed on the bottom plate, and the conveyance skin material covering the bottom plate and the pad material are provided. It is preferable that a plurality of through-holes are formed on a front surface of the bottom plate. It is preferable that the skin overlapping portion is disposed at a position that does not overlap the through-holes of the bottom plate when the conveyance seat is viewed from above.

With the above-described configuration, the bottom plate can provide a suitable support at the skin overlapping portion where a load from a seated occupant is relatively likely to be applied.

In this case, it is preferable that the first skin terminal portion is disposed at a position overlapping the through-holes of the bottom plate when the conveyance seat is viewed from above.

As described above, since the through-holes of the bottom plate are provided to correspond to the first skin terminal portion (extension portion) where the load from the seated occupant is relatively less likely to be applied, breathability provided by the through-holes can be enhanced while ensuring the durability of the conveyance seat. In addition, a reduction in weight can also be achieved by the through-holes.

In this case, it is preferable that a bottom plate, the pad material disposed on the bottom plate, and the conveyance skin material covering the bottom plate and the pad material are provided. It is preferable that a reinforcing recess recessed toward a front surface side or a back surface side of the bottom plate is formed on a front surface of the bottom plate. It is preferable that the skin overlapping portion is disposed at a position overlapping the reinforcing recess of the bottom plate when the conveyance seat is viewed from above.

In addition, it is preferable that the first skin terminal portion is disposed at a position that does not overlap the reinforcing recess of the bottom plate when the conveyance seat is viewed from above.

With the above-described configuration, the bottom plate (reinforcing recess) can provide a suitable support at the skin overlapping portion where the load from the seated occupant is relatively likely to be applied. In addition, the reinforcing recess of the bottom plate can be disposed at a position that does not correspond to the first skin terminal portion (extension portion) where the load from the seated occupant is relatively less likely to be applied.

In the above-described embodiment, the conveyance skin material and the conveyance seat have been mainly described.

However, the above-described embodiment is merely one example for easy understanding of the present invention, and does not limit the present invention. The present invention can be modified and improved without departing from the concept of the present invention, and it goes without saying that the present invention includes its equivalents.

### Electric Two-Wheeled Vehicle of First Embodiment

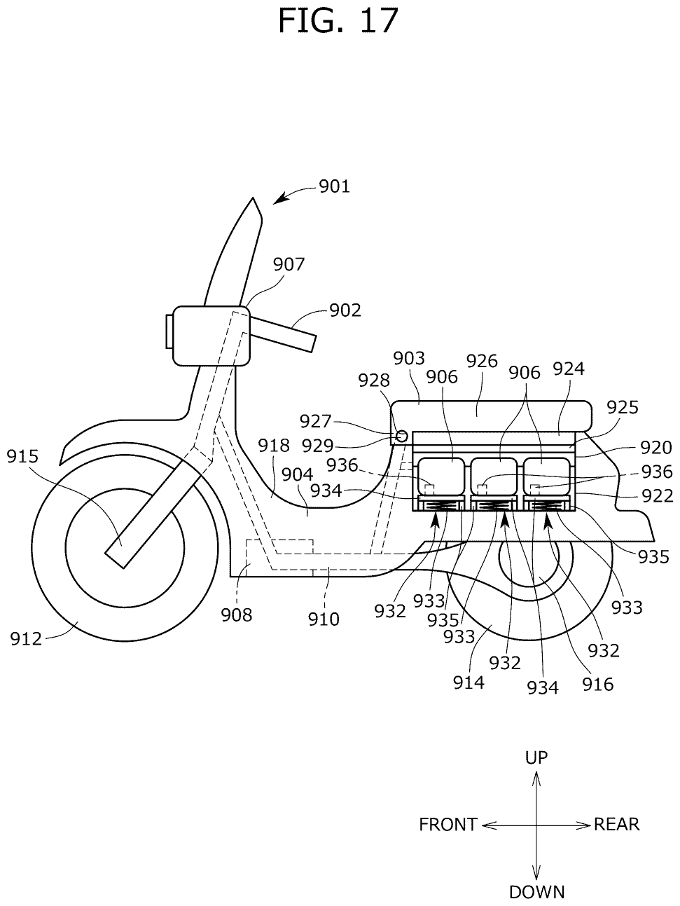

Next, an electric two-wheeled vehicle of a first embodiment will be described with reference to FIG. 17.

An electric two-wheeled vehicle 901 realizes an electric two-wheeled vehicle in which the replacement work of a battery is facilitated.

A traveling direction of the electric two-wheeled vehicle 901 is defined as a front to rear direction, and each of a right to left direction and an up to down direction are defined for the following description.

As shown in FIG. 17, the electric two-wheeled vehicle 901 is a scooter-type electric two-wheeled vehicle, and includes operating handlebars 902; a seat 903 on which a user is seated; and a footrest portion 904 which is provided between the operating handlebars 902 and the seat 903 and on which the user places the feet. A plurality of first batteries 906 that are rechargeable are disposed on the rear side of the electric two-wheeled vehicle 901. Each of the first batteries 906 is a secondary battery such as a lithium ion battery that stores electric power, and is detachably provided in the electric two-wheeled vehicle 901. The electric two-wheeled vehicle 901 travels by electric power supplied from the first batteries 906.

In addition, the electric two-wheeled vehicle 901 includes a meter 907 and a second battery 908. The meter 907 includes a display screen, for example, a liquid crystal display or the like, and is provided in the vicinity of the operating handlebars 902. The second battery 908 is disposed inside the footrest portion 904. The meter 907 and the second battery 908 are connected to each other via a control device (not shown), and the meter 907 displays various information about the electric two-wheeled vehicle 901, for example, the speed of the electric two-wheeled vehicle 901, the remaining level of the first batteries 906, and the like, using electric power supplied from the second battery 908.

The electric two-wheeled vehicle 901 includes a vehicle body frame 910 forming the skeleton of the electric two-wheeled vehicle 901, and a front wheel 912 and a rear wheel 914 supported by the vehicle body frame 910. The front wheel 912 is supported by a front fork 915 forming the front side of the vehicle body frame 910. The rear wheel 914 is supported via a drive unit 916 provided on the rear side of the vehicle body frame 910. In addition, in the electric two-wheeled vehicle 901, a vehicle body cover 918 for forming a vehicle body is disposed to cover the vehicle body frame 910.

The drive unit 916 is provided with an electric motor (not shown). The electric motor is electrically connected to the first batteries 906 via wire harnesses and connectors 936 (not shown). The electric motor is rotationally driven by receiving electric power supplied from the first batteries 906. The rotational drive of the electric motor is transmitted to the rear wheel 914 via the drive unit 916. Accordingly, the electric two-wheeled vehicle 901 travels.

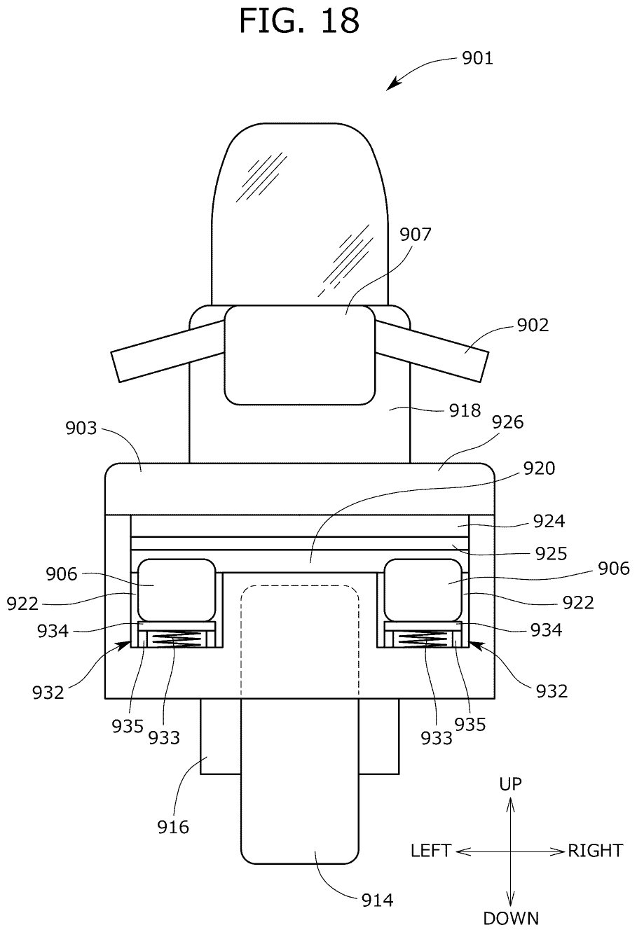

A storage box 920 is provided on a rear wheel 914 side of the electric two-wheeled vehicle 901. The storage box 920 has a box shape in which a skeleton of the storage box 920 is formed by the vehicle body frame 910 and of which the top is opened by the vehicle body cover 918 that covers the vehicle body frame 910. The storage box 920 has a recessed shape when viewed from the front, in which a bottom portion on each of right and left sides protrudes further downward than a bottom portion at the center. As shown in conjunction with FIG. 18, a center portion of the storage box 920 is aligned with the rear wheel 914 when viewed from the front. Therefore, the bottom portion on each of the right and left sides of the storage box 920 is aligned with an upper portion of the rear wheel 914 when viewed from the side. The storage box 920 has a storage space defined by each inner surface of the vehicle body cover 918.

The storage box 920 includes battery receiving portions 922 that are recesses for receiving the first batteries 906, and a small item storage portion 924 (storage portion) formed integrally with the battery receiving portions 922 and provided above the battery receiving portions 922. Specifically, as shown in conjunction with FIG. 18, the battery receiving portions 922 correspond to a lower portion (bottom portion side) of the storage box 920, and the small item storage portion 924 corresponds to an upper portion of the storage box 920.

The battery receiving portion 922 corresponds to the bottom portion of each of the right and left sides of the storage box 920. Namely, the battery receiving portions 922 are disposed on the right and left outer sides of the rear wheel 914. Each of the battery receiving portions 922 is open upward. Accordingly, storage spaces of the battery receiving portions 922 (spaces for storing the first batteries 906) and a storage space of the small item storage portion 924 communicate with each other. It is preferable that a depth of each of the battery receiving portions 922 is provided to be equal to a thickness of the corresponding first battery 906. Accordingly, when each of the first batteries 906 is received in the corresponding battery receiving portion 922, an upper surface of each of the first batteries 906 is disposed on the same plane as an inner surface of the center portion of the storage box 920.

The electric two-wheeled vehicle 901 includes an inner lid 925 that partitions each of the battery receiving portions 922 and the small item storage portion 924 off from each other, and that is attachable to and detachable from the vehicle body frame 910. The inner lid 925 has a plate shape, a front-to-rear length of the inner lid 925 is equal to an inner front-to-rear length of the small item storage portion 924, and a right-to-left width of the inner lid 925 is equal to an inner right-to-left width of the small item storage portion 924. The inner lid 925 is provided at a predetermined position inside the storage box 920, and is supported by ribs (not shown) protruding inward. It is preferable that the ribs are provided below the small item storage portion 924 and above an opening of each of the battery receiving portions 922. Accordingly, the inner lid 925 is disposed above the battery receiving portions 922 so as to close the opening of each of the battery receiving portions 922.

The inner lid 925 functions as the bottom of the small item storage portion 924. Namely, the storage space of the small item storage portion 924 of which the top is open is defined above the inner lid 925. Tools and the like are stored in the storage space. Since the inner lid 925 functions as the bottom of the small item storage portion 924, the stored tools and the like do not come into contact with the first batteries 906. Therefore, damage to the first batteries 906 is suppressed.

The vehicle body frame 910 is provided with a first lid portion 926 (lid portion) capable of opening and closing an upper portion of the storage box 920. The first lid portion 926 may be a plate-shaped member, and may be formed by covering a metal frame with a skin material made of flexible resin, natural leather, or synthetic leather, or the like. Namely, the first lid portion 926 has a lower surface facing the inside of the storage box 920, and an upper surface facing the lower surface and facing outward.

A pair of right and left protruding pieces 927 protruding downward are provided at a front end of the first lid portion 926. Each of the protruding pieces 927 is provided with a through-hole 928 penetrating therethrough in the right to left direction. A pivot shaft 929 having a rod shape that is a part of the vehicle body frame 910, that is disposed at an upper front portion of the storage box 920, and that extends to the right and left and penetrates through each of the through-holes 928. Accordingly, the first lid portion 926 is provided on the vehicle body frame 910. The first lid portion 926 is provided to be rotatable about the pivot shaft 929 serving as a rotating shaft. Therefore, the first lid portion 926 is displaced between a closed state where the internal space of the storage box 920 is closed and an open state where the internal space of the storage box 920 is opened. Even when the inner lid 925 is not disposed, the rotation of the first lid portion 926 causes the first lid portion 926 to transition between a state where the battery receiving portions 922 are closed and a state where the battery receiving portions 922 are opened.

The seat 903 is provided on the first lid portion 926. Namely, an upper surface of the first lid portion 926 corresponds to a seating surface on which an occupant is seated. When the first lid portion 926 is in the closed state, a user can be seated. In other words, when the user is seated and drives the electric two-wheeled vehicle, the first lid portion 926 maintains the closed state.

The electric two-wheeled vehicle 901 includes an assist device 932 for moving the first battery 906 to an opening side of the battery receiving portion 922. The assist device 932 may be a conventionally known push mechanism including a plurality of elastic members 933 that are displaceable in the up to down direction; a placement member 934 connected to each of the plurality of elastic members 933; and locking means 935 for locking the placement member 934 against the biasing force of the elastic members 933. The elastic members 933 are coil springs, and are disposed such that the biasing force thereof is directed upward. Lower ends of the elastic members 933 are connected to a lower portion of the battery receiving portion 922, and upper ends of the elastic members 933 are connected to the placement member 934. The placement member 934 has a plate shape, and is disposed such that a main surface of the placement member 934 is oriented in the up to down direction. An upper surface of the placement member 934 forms a placement surface for placing the first battery 906. When the biasing force of the elastic members 933 does not act, it is preferable that the placement member 934 is disposed above the opening of the battery receiving portion 922.

The locking means 935 is provided in the battery receiving portion 922. When the placement member 934 is pressed downward, the placement member 934 is locked by the locking means 935. Accordingly, the placement member 934 is disposed at a lower portion of the battery receiving portion 922 in a state where the placement member 934 resists the biasing force of the elastic members 933. When the placement member 934 is pressed downward again in this state, the locking between the placement member 934 and the storage box 920 is released, and the biasing force of the elastic members 933 acts to move the placement member 934 upward toward the opening side of the battery receiving portion 922.

The placement member 934 is provided with the connector 936. The first battery 906 is connected to the connector 936 by placing the first battery 906 on the placement member 934. Accordingly, the first battery 906 is electrically connected to the electric two-wheeled vehicle 901.

In the present embodiment, the assist device 932 is provided for each of the first batteries 906; however, the number of the first batteries 906 is not particularly limited. Therefore, the assist device 932 can be changed as appropriate according to the number of the first batteries 906.

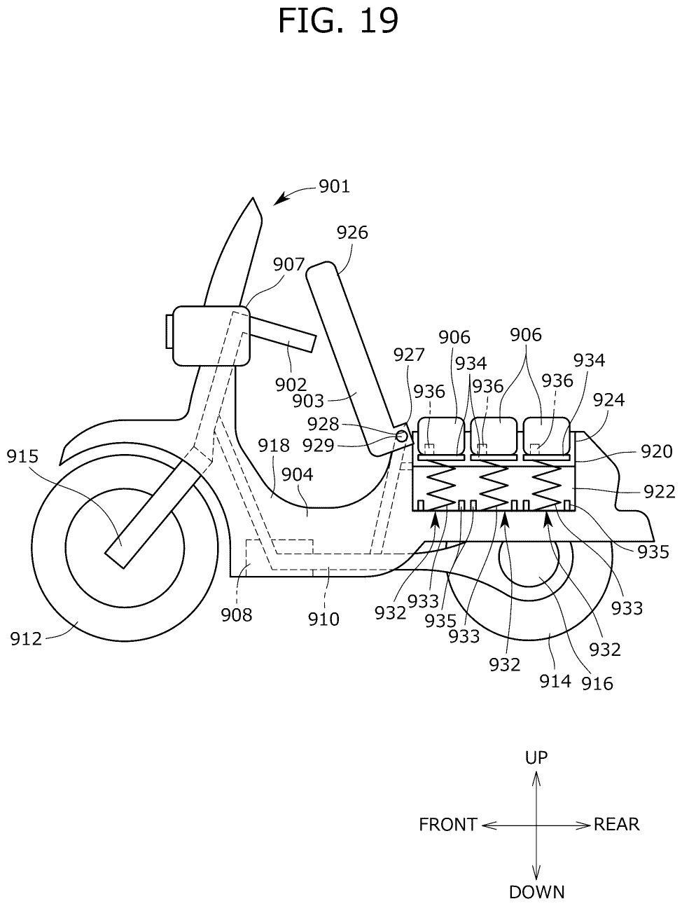

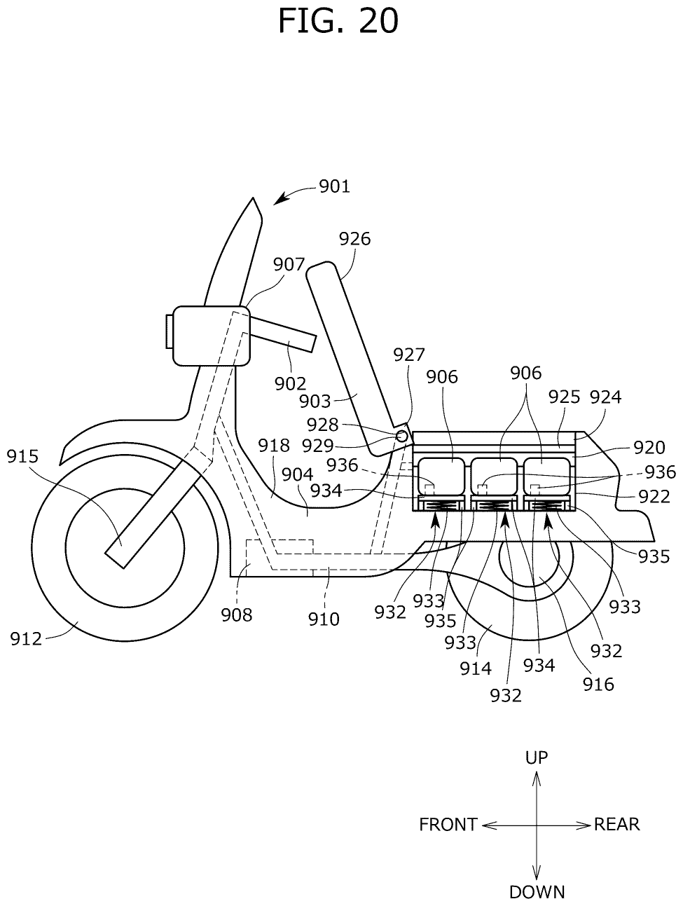

In the work of receiving the first battery 906 in the battery receiving portion 922, first, as shown in FIG. 19, the user opens the top of the storage box 920 by setting the first lid portion 926 to the open state. At this time, the placement member 934 is disposed upward toward the opening side of the battery receiving portion 922. Next, the user places the first battery 906 on the placement member 934. At this time, the placement member 934 is disposed on the opening side of the battery receiving portion 922. Thereafter, the user pushes the first battery 906 downward. When the first battery 906 is pushed, the placement member 934 is also pushed downward. When the placement member 934 is pushed to a predetermined position, as shown in FIG. 20, the placement member 934 is locked to the battery receiving portion 922 by the locking means 935. Accordingly, the placement member 934 is disposed at the lower portion of the battery receiving portion 922 against the biasing force of the elastic members 933. Therefore, the first battery 906 is received in the battery receiving portion 922. Thereafter, as shown in FIG. 17, the user closes the top of the storage box 920 by setting the first lid portion 926 to the closed state, so that the user can be seated on the seat 903.

In the work of removing the first battery 906 from the battery receiving portion 922, first, as shown in FIG. 20, the user opens the top of the storage box 920 by setting the first lid portion 926 to the open state. Next, the user pushes the first battery 906 downward. When the first battery 906 is pushed, the placement member 934 is also pushed downward. Accordingly, the locking between the placement member 934 and the locking means 935 is released. At this time, as shown in FIG. 19, the biasing force of the elastic members 933 acts to move the placement member 934 from the lower portion toward the upper portion of the battery receiving portion 922, and the first battery 906 is also pushed upward from the battery receiving portion 922. When the biasing force of the elastic members 933 does not act, the placement member 934 is disposed above the opening of the battery receiving portion 922, so that the first battery 906 is disposed above the opening of the battery receiving portion 922.

In the work of receiving the first battery 906 in the battery receiving portion 922 and the work of removing the first battery 906 from the battery receiving portion 922, the inner lid 925 is removed from the storage box in advance. It is preferable that the user causes the battery receiving portion 922 to receive the first battery 906 and then attaches the inner lid 925 to the storage box.

As shown in FIGS. 17 and 18, the battery receiving portions 922 are disposed on the right and left outer sides of the rear wheel 914. In addition, when the first battery 906 is removed, the assist device 932 moves the first battery 906 upward. Accordingly, when the user removes the first battery 906, the first battery 906 is disposed above the battery receiving portion 922 by the assist device 932. Namely, the bending movement or squatting movement of the user is suppressed. Therefore, the replacement work of the first battery 906 is facilitated.

As shown in FIGS. 19 and 20, the first lid portion 926 is provided to enable the top of the storage box 920 to be opened and closed. When the first lid portion 926 is in the closed state where the top of the storage box 920 is closed, the user can be seated on the seat 903 and drive the electric two-wheeled vehicle 901. Accordingly, during traveling of the electric two-wheeled vehicle 901, the unintended operation of the assist device 932 by the user is suppressed.

The inner lid 925 partitions each of the battery receiving portions 922 and the small item storage portion 924 off from each other, and closes the opening of each of the battery receiving portions 922. Accordingly, tools and the like stored in the small item storage portion 924 do not come into contact with the first batteries 906. Therefore, the release of the locking between the placement member 934 and the locking means 935, which is caused by the downward pushing of the first batteries 906 due to the weight of the tools and the like stored in the small item storage portion 924, is suppressed.

### Electric Two-Wheeled Vehicle of Second Embodiment

The electric two-wheeled vehicle 901 of a second embodiment differs from the electric two-wheeled vehicle 901 according to the first embodiment only in the configuration of the assist device 932. The same configurations as those in the electric two-wheeled vehicle 901 according to the first embodiment are denoted by the same reference signs, and the description thereof will be omitted.

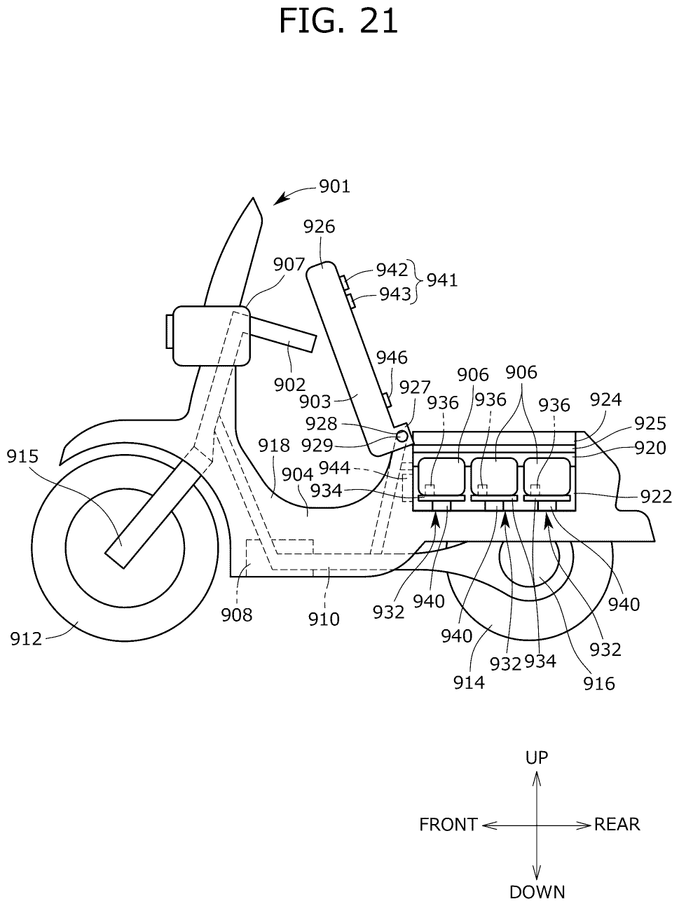

As shown in FIG. 21, the assist device 932 is a known electric lifting mechanism including a casing 940 including a plurality of tubular bodies connected to each other in a telescopic manner, and an electric actuator (not shown). The casing 940 is disposed at the lower portion of the battery receiving portion 922 so as to be movable in the up to down direction by the electric actuator. A lower end of the outermost tubular body is connected to the lower portion of the battery receiving portion 922, and the placement member 934 is disposed at an upper end of the innermost tubular body.

The assist device 932 includes a switch unit 941 for receiving an operation to move the casing 940 in the up to down direction. The switch unit 941 includes an up switch 942 for receiving an operation to move the casing 940 upward, and a down switch 943 for receiving an operation to move the casing 940 downward. Each of the switches 942 and 943 may be a momentary switch, and is provided on a back side (lower surface side) of the first lid portion 926. The switch unit 941 and the assist device 932 are connected to the second battery 908 provided in the electric two-wheeled vehicle 901 via a control device 944.

The control device 944 includes an arithmetic processing unit (a processor such as a CPU or an MPU) and a storage device (a memory such as a ROM or a RAM), and is configured to execute various processes required for the operation of the assist device 932. Being configured to execute various processes means that the arithmetic processing unit (processor) is programmed to read necessary data and application software from the storage device (memory) and perform a predetermined arithmetic process according to the software. The control device 944 may be configured as a single piece of hardware, or may be configured as a unit composed of a plurality of pieces of hardware.

When the user presses one of the switches 942 and 943, the control device 944 causes the casing 940 to operate via the electric actuator in response to the operation of the pressed switch unit 941 using electric power supplied from the second battery 908. Namely, when the up switch 942 is pressed, the control device 944 causes the casing 940 to move upward. When the down switch 943 is pressed, the control device 944 causes the casing 940 to move downward.

A sensor unit 946 that detects the closed state and the open state of the first lid portion 926 is provided on the back side of the first lid portion 926. The sensor unit 946 is not particularly limited, but may be a light sensor that detects light. When the first lid portion 926 is in the closed state, the internal space of the storage box 920 is closed, so that light from the outside is blocked. On the other hand, when the first lid portion 926 is in the open state, the internal space of the storage portion is opened, so that light from the outside is incident on the inside of the storage box 920. Therefore, the sensor unit 946 sets a state where light from the outside is blocked (a state where the intensity of light is weak) as the closed state, and sets a state where light from the outside is incident on the inside of the storage portion (a state where the intensity of light is strong) as the open state.

Alternatively, the sensor unit 946 may cooperate with a key cylinder (not shown). In this case, when the key cylinder is in an ON state, the sensor unit 946 may be set to the closed state, and when the key cylinder is in an OFF state, the sensor unit 946 may be set to the open state.

The sensor unit 946 and the assist device 932 are connected to each other via the control device 944. When the sensor unit 946 detects the open state, the control device 944 allows the operation of the assist device 932 in response to the operation of each switch. Meanwhile, when the sensor unit 946 detects the open state, the control device 944 suppresses the operation of the assist device 932 regardless of the operation of each switch.

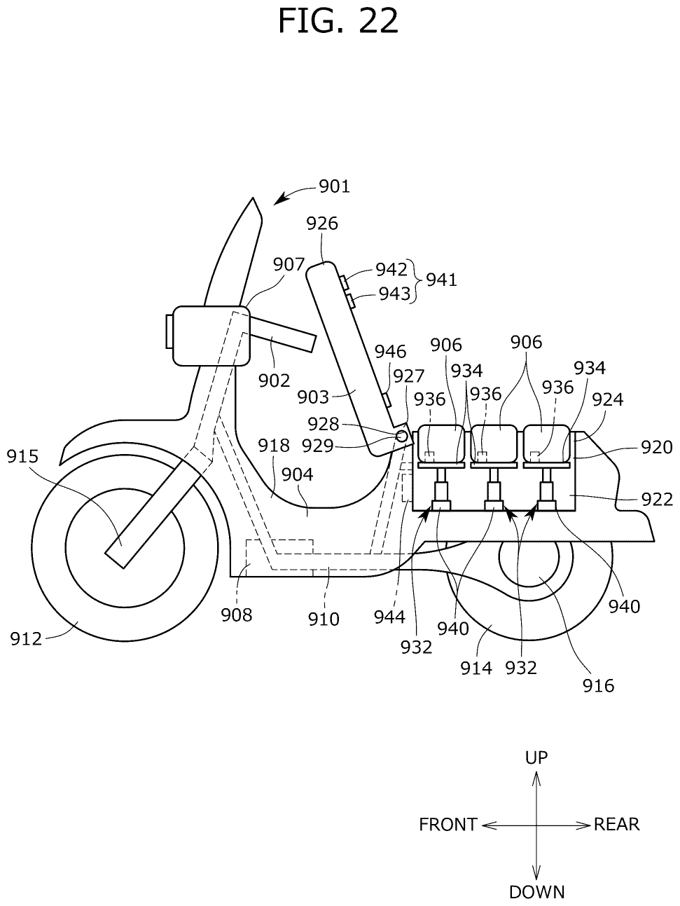

In the work of receiving the first battery 906 in the battery receiving portion 922, first, as shown in FIG. 22, the user opens the top of the storage box 920 by setting the first lid portion 926 to the open state. At this time, the casing 940 of the assist device 932 extends upward. Accordingly, the sensor unit 946 detects the open state, and the control device 944 allows the operation of the assist device 932. Next, the user places the first battery 906 on the placement member 934. At this time, the placement member 934 is disposed on the opening side of the battery receiving portion 922. Thereafter, the user moves the casing 940 downward as shown in FIG. 21 by pressing the down switch 943. In cooperation with this movement, the first battery 906 is received in the battery receiving portion 922.

In the work of removing the first battery 906 from the battery receiving portion 922, first, as shown in FIG. 21, the user opens the top of the storage box 920 by setting the first lid portion 926 to the open state. Accordingly, the sensor unit 946 detects the open state, and the operation of the assist device 932 is allowed. Next, the user moves the casing 940 upward as shown in FIG. 22 by pressing the up switch 942. In cooperation with this movement, the first battery 906 is also pushed upward from the battery receiving portion 922.

In the work of receiving the first battery 906 in the battery receiving portion 922 and the work of removing the first battery 906 from the battery receiving portion 922 in response to the switch unit 941 for receiving an operation to move the casing 940 in the up to down direction, the bending movement or squatting movement of the user is suppressed. Therefore, the work of attaching and detaching the first battery 906 to and from the electric two-wheeled vehicle 901 is facilitated. By providing the switch unit 941 on the back side of the first lid portion 926, during traveling of the electric two-wheeled vehicle 901, the unintended operation of the assist device 932 by the user is suppressed.

In addition, the sensor unit 946 for detecting the closed state and the open state of the first lid portion 926 is provided on the back side of the first lid portion 926. The sensor unit 946 is connected to the assist device 932 via the control device 944. When the sensor unit 946 detects the open state, the control device 944 allows the operation of the assist device 932 in response to the operation of each switch. Meanwhile, when the sensor unit 946 detects the open state, the control device 944 suppresses the operation of the assist device 932 regardless of the operation of each switch. Accordingly, the pressing of the switch unit 941 by tools or the like stored in the small item storage portion 924 is suppressed. Therefore, the unintended operation of the assist device 932 by the user is suppressed.

### Electric Two-Wheeled Vehicle of Third Embodiment

The electric two-wheeled vehicle 901 of a third embodiment differs from the electric two-wheeled vehicle 901 according to the first embodiment only in the configurations of the battery receiving portion 922 and the assist device 932. The same configurations as those in the electric two-wheeled vehicle 901 according to the first embodiment are denoted by the same reference signs, and the description thereof will be omitted.

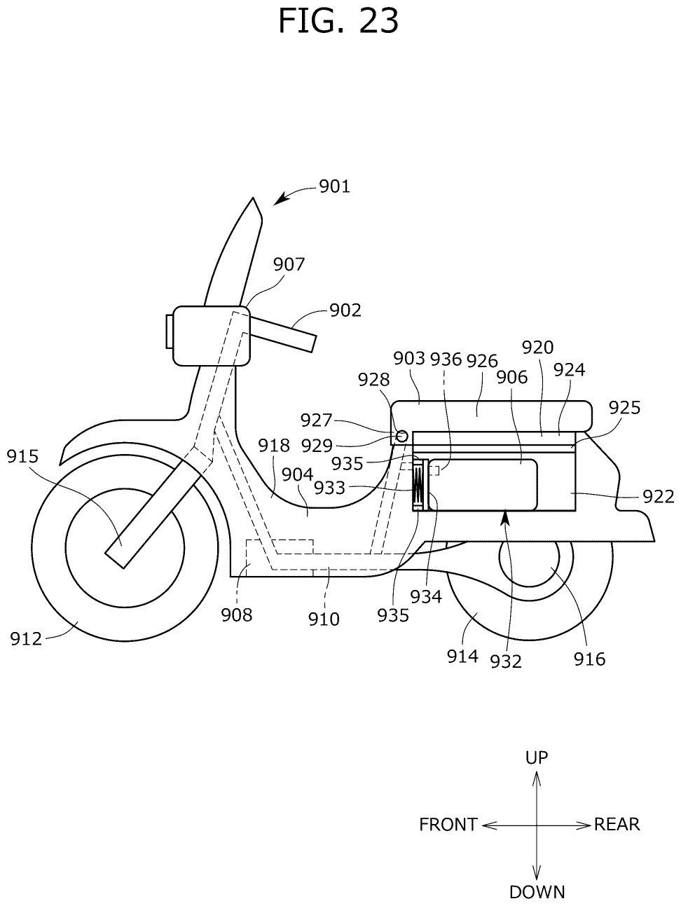

As shown in FIG. 23, each of the battery receiving portions 922 receives one first battery 906. The battery receiving portion 922 has a box shape with an open rear. The user moves the first battery 906 from the rear to the front of the battery receiving portion 922, so that the first battery 906 is received in the battery receiving portion 922. At this time, a rear end of the first battery 906 is located in front of a rear opening of the battery receiving portion 922.

It is preferable that a second lid portion (not shown) capable of opening and closing the rear opening of the battery receiving portion 922 is provided at the rear of the battery receiving portion 922. The second lid portion has a plate shape, and may be provided in a storage hole (not shown) provided in the storage box 920 so as to be displaceable in the up to down direction. In this case, when the second lid portion is displaced to a lowermost position, the second lid portion closes the rear opening of the battery receiving portion 922. When the second lid portion is displaced to an uppermost position, the second lid portion is stored in the storage hole, and the rear of the battery receiving portion 922 is opened.

The assist device 932 is provided at a front portion of the battery receiving portion 922. Specifically, a front end of the elastic member 933 is connected to a front end of the battery receiving portion 922 such that the elastic member 933 is displaceable in the front to rear direction. The placement member 934 is connected to a rear end of the elastic member 933. At this time, the main surface of the placement member 934 faces in the front to rear direction. The locking means 935 is provided at the front end of the battery receiving portion 922. When the biasing force of the elastic member 933 does not act, the position of the placement member 934 is not particularly limited; however, it is preferable that the placement member 934 is disposed at a center portion of the storage portion for the first battery 906.

When the placement member 934 is pressed forward, the placement member 934 is locked by the locking means 935. Accordingly, the placement member 934 is disposed on the front side of the battery receiving portion 922 in a state where the placement member 934 resists the biasing force of the elastic member 933. When the placement member 934 is pressed forward again in this state, the locking between the placement member 934 and the locking means 935 is released, and the biasing force of the elastic member 933 acts to move the placement member 934 rearward toward an opening side of the battery receiving portion 922.

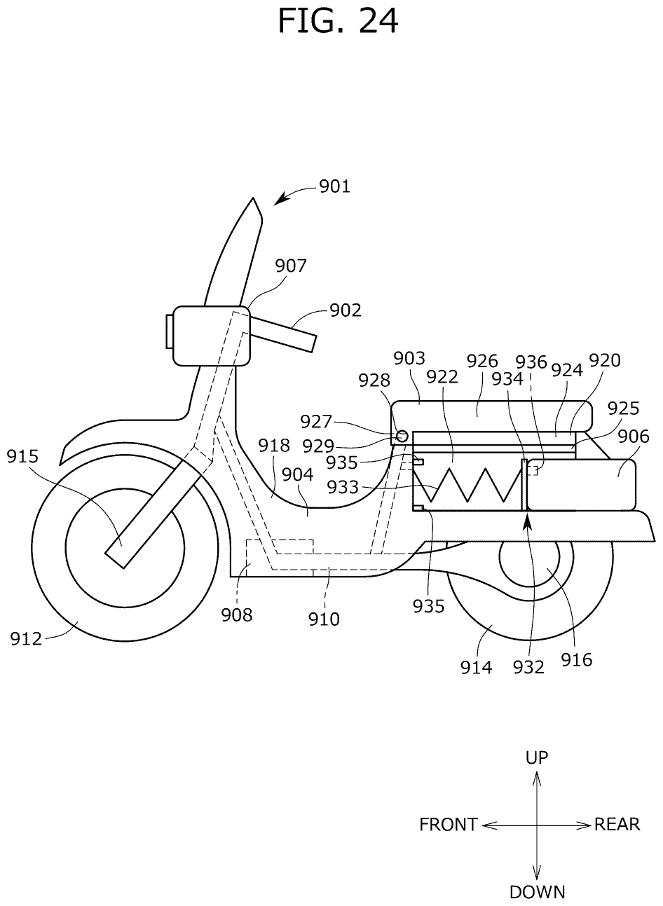

In the work of receiving the first battery 906 in the battery receiving portion 922, the user opens the rear of the battery receiving portion 922 by storing the second lid portion in the storage hole. At this time, the placement member 934 is disposed at the center portion of the storage portion for the first battery 906. Next, as shown in FIG. 24, the user brings a front end of the first battery 906 into contact with the placement member 934. At this time, the placement member 934 is disposed on the opening side of the battery receiving portion 922. Thereafter, the user pushes the first battery 906 forward. When the first battery 906 is pushed, the placement member 934 is also pushed forward. When the placement member 934 is pushed to a predetermined position, the placement member 934 is locked to the battery receiving portion 922 by the locking means 935. Accordingly, as shown in FIG. 23, the placement member 934 is disposed at the front portion of the battery receiving portion 922 against the biasing force of the elastic member 933. Therefore, the first battery 906 is received in the battery receiving portion 922. Thereafter, the user closes the rear opening of the battery receiving portion 922 by moving the second lid portion downward from the storage hole.

In the work of removing the first battery 906 from the battery receiving portion 922, first, the user moves the second lid portion upward so as to be stored in the storage hole. Accordingly, the rear of the battery receiving portion 922 is opened. Next, as shown in FIG. 23, the user pushes the first battery 906 forward. When the first battery 906 is pushed, the placement member 934 is also pushed forward. Accordingly, the locking between the placement member 934 and the locking means 935 is released. At this time, as shown in FIG. 24, the biasing force of the elastic member 933 acts to move the placement member 934 from the front portion toward the rear portion of the battery receiving portion 922, and the first battery 906 is also pushed rearward from the battery receiving portion 922. At a position where the biasing force of the elastic member 933 does not act, a rear portion of the first battery 906 protrudes rearward from the rear opening of the battery receiving portion 922. Accordingly, the work of removing the first battery 906 is facilitated.

### Electric Two-Wheeled Vehicle of Fourth Embodiment

The electric two-wheeled vehicle 901 of a fourth embodiment differs from the electric two-wheeled vehicle 901 according to the first embodiment only in the configurations of the storage box 920 and the first lid portion 926. The same configurations as those in the electric two-wheeled vehicle 901 according to the first embodiment are denoted by the same reference signs, and the description thereof will be omitted.

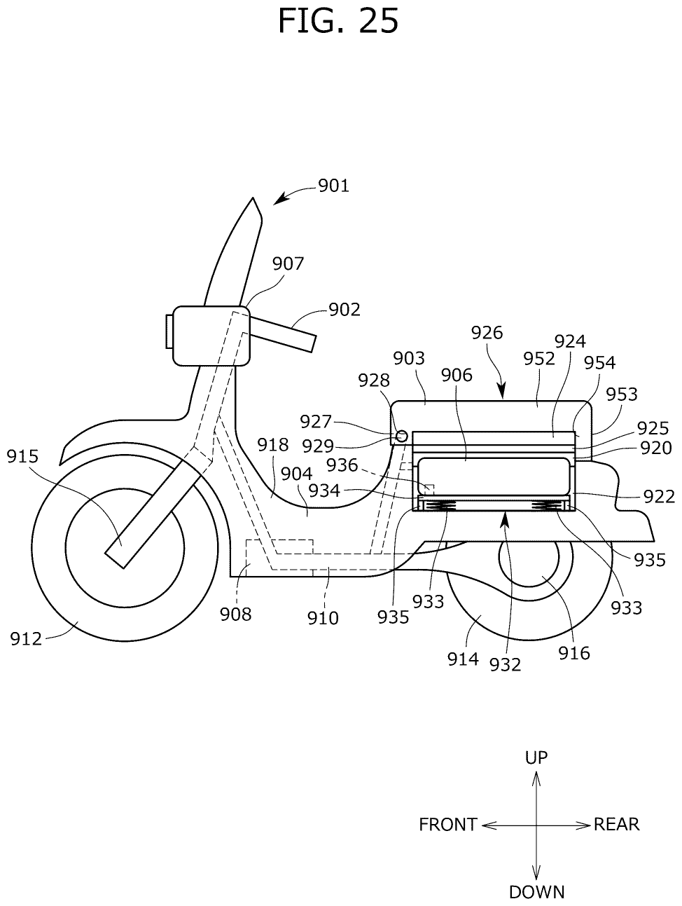

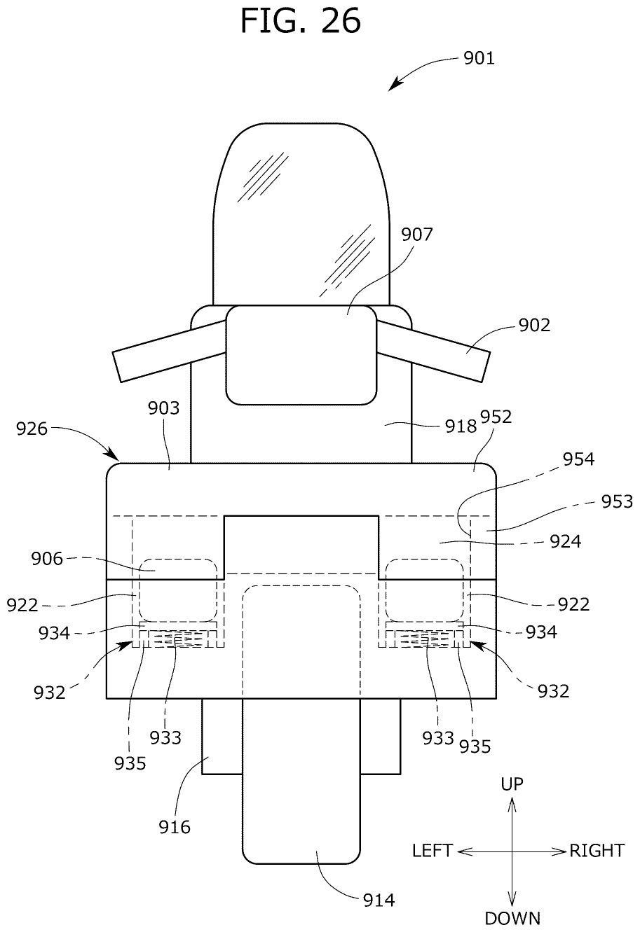

As shown in FIGS. 25 and 26, the storage box 920 has a box shape in which a skeleton of the storage box 920 is formed by the vehicle body frame 910 and then the top and the rear thereof are opened by the vehicle body cover 918 that covers the vehicle body frame 910. Specifically, an opening 954 is provided at a rear of the small item storage portion 924 forming the top of each of the battery receiving portions 922.

The first lid portion 926 includes a first member 952 extending in the front to rear direction and a second member 953 extending downward from a rear end of the first member 952 in the closed state where the internal space of the storage box 920 is closed. The first member 952 has a lower surface facing the inside of the storage box 920, and an upper surface facing the lower surface and facing outward. The second member 953 has a front surface facing the inside of the storage box 920, and a rear surface facing the front surface and facing outward.

In the closed state where which the internal space of the storage box 920 is closed, the first member 952 is disposed to close the top of the storage box 920, and the second member 953 is disposed to close the opening 954 provided at the rear of the storage box 920.

Each of the battery receiving portions 922 receives one first battery 906. The placement member 934 has a plate shape, and is provided with dimensions equal to inner dimensions of the battery receiving portion 922 in the front to rear direction and the right to left direction. The elastic members 933 that are displaceable in the up to down direction are connected to each of a front portion and a rear portion of the placement member 934. The locking means 935 is provided at each of the front portion and the rear portion of the battery receiving portion 922.

When no biasing force acts on each of the elastic members 933, the front end of the elastic member 933 connected to the rear portion of the placement member 934 is located at a higher position than the front end of the elastic member 933 connected to the front portion of the placement member 934, and is at a position that is aligned with a lower portion of the rear opening of the storage box 920 when viewed from the front. Namely, when no biasing force acts on each of the elastic members 933, the placement member 934 is disposed in a state where the placement member 934 is inclined upward toward the rear.

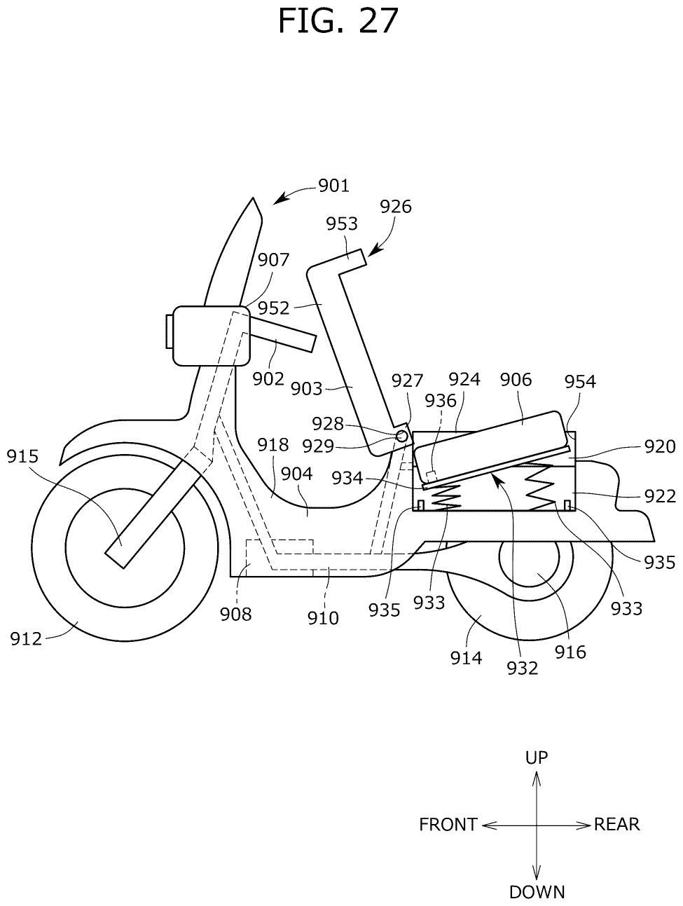

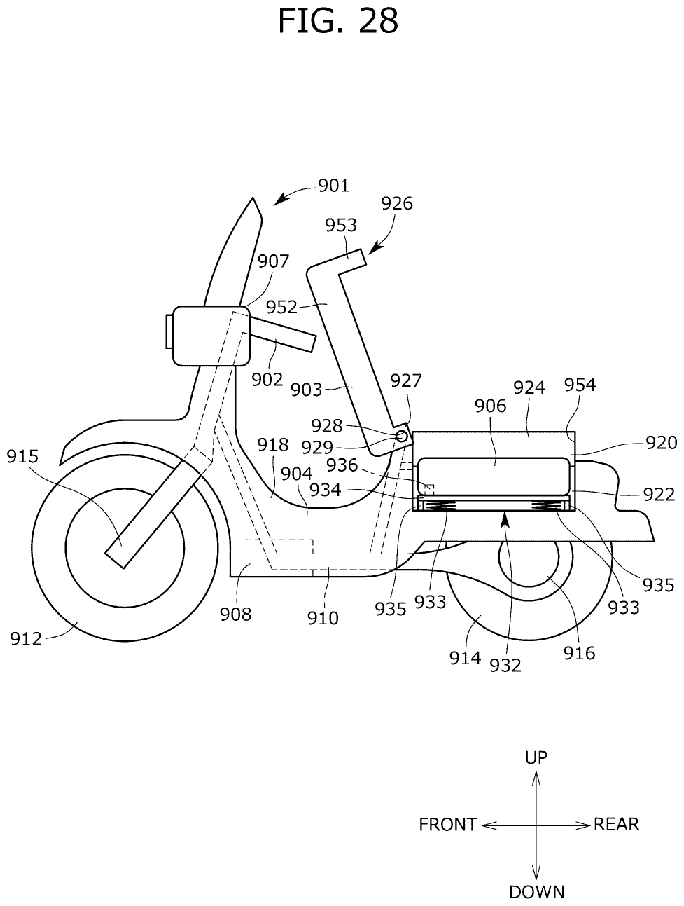

In the work of receiving the first battery 906 in the battery receiving portion 922, first, as shown in FIG. 27, the user opens the top and the rear of the storage box 920 by setting the first lid portion 926 to the open state. At this time, the placement member 934 is disposed to be inclined upward toward the rear. Next, the user places the first battery 906 on the placement member 934. At this time, the placement member 934 is located on the opening side of the battery receiving portion 922, and the placement member 934 is disposed in a state where the placement member 934 is inclined upward toward the rear. Thereafter, the user pushes the first battery 906 downward. When the first battery 906 is pushed, the placement member 934 is also pushed downward. When the placement member 934 is pushed to a predetermined position, as shown in FIG. 28, the placement member 934 is locked to the battery receiving portion 922 by the locking means 935. Accordingly, the placement member 934 is disposed at the lower portion of the battery receiving portion 922 against the biasing force of the elastic members 933. Therefore, the first battery 906 is received in the battery receiving portion 922. Thereafter, the user closes the top of the storage box 920 by setting the first lid portion 926 to the closed state, so that the user can be seated on the seat 903.

In the work of removing the first battery 906 from the battery receiving portion 922, first, as shown in FIG. 28, the user opens the top and the rear of the storage box 920 by setting the first lid portion 926 to the open state. Next, the user pushes the first battery 906 downward. When the first battery 906 is pushed, the placement member 934 is also pushed downward. Accordingly, the locking between the placement member 934 and the locking means 935 is released. At this time, the biasing force of each of the elastic members 933 acts to move the placement member 934 from the lower portion toward the upper portion of the battery receiving portion 922, and the first battery 906 is also pushed upward from the battery receiving portion 922. When no biasing force acts on each of the elastic members 933, the placement member 934 is inclined upward toward the rear, so that, as shown in FIG. 27, the first battery 906 is also disposed in a state where the first battery 906 is inclined upward toward the rear. At this time, the rear end of the first battery 906 is disposed above the opening side of the battery receiving portion 922.

In the work of receiving the first battery 906 in the battery receiving portion 922 and the work of removing the first battery 906 from the battery receiving portion 922, the first battery 906 is inclined upward. In the work of receiving the first battery 906 in the battery receiving portion 922, when the first battery 906 is placed on the placement member 934, a component of the weight of the first battery 906 in an inclination direction of the placement member 934 acts. Accordingly, the force exerted by the user to push the first battery 906 is reduced. In addition, in the work of removing the first battery 906 from the battery receiving portion 922, since the top and the rear of the storage box 920 are opened, the user can remove the first battery 906 in an ergonomically good posture. Accordingly, the work of removing the first battery 906 is facilitated.

The description of the specific embodiments has been completed above; however, the present invention is not limited to the above-described embodiments, and can be modified and implemented in a variety of forms.

In each of the embodiments, the front end of the first lid portion 926 is connected to the vehicle body frame 910; however, a rear end of the first lid portion 926 may be connected to the vehicle body frame 910. In addition, when the front end of the first lid portion 926 is connected to the vehicle body frame 910, locking means for locking to the vehicle body frame 910 is provided at the rear end of the first lid portion 926. Accordingly, when the first lid portion 926 is in the closed state, the first lid portion 926 is locked by the locking means. Therefore, unintended opening of the first lid portion 926 by the user is suppressed.

### Supplementary Notes on Electric Two-Wheeled Vehicles of First to Fourth Embodiments

It is preferable that the conveyance skin material described above is an electric two-wheeled vehicle (901) that travels by electric power from a rechargeable battery (906), comprising: a vehicle body frame (910); a front wheel (912) and a rear wheel (914) supported by the vehicle body frame; battery receiving portions (922) that are recesses provided in the vehicle body frame to receive the battery; and an assist device (932) that moves the battery to an opening side of the battery receiving portion. It is preferable that the battery receiving portions are disposed on the right and left outer sides of the rear wheel.

According to this aspect, when a user removes the battery, the battery is disposed above the battery receiving portion by the assist device. Namely, the bending movement or squatting movement of the user is suppressed. Therefore, the replacement work of the battery is facilitated.

In this case, the vehicle body frame may be provided with a lid portion (926) that opens and closes the battery receiving portion. In a closed state where the lid portion closes the battery receiving portion, the assist device may restrict the movement of the battery, and in an open state where the lid portion opens the battery receiving portion, the assist device may move the battery to the opening side.

According to this aspect, during traveling of the electric two-wheeled vehicle, the unintended operation of the assist device by the user is suppressed.

In this case, the battery receiving portion may open upward, and a seat (903) on which a user is seated may be provided on the lid portion.

According to this aspect, during traveling of the electric two-wheeled vehicle, the lid portion is closed due to the user being seated on the seat. Therefore, the unintended operation of the assist device by the user is suppressed.

In this case, the lid portion may maintain the closed state when the electric two-wheeled vehicle travels.

According to this aspect, during traveling of the electric two-wheeled vehicle, the unintended operation of the assist device by the user is suppressed.

In this case, when the lid portion is in the open state, at least a part of the battery may protrude outward from the opening side of the battery receiving portion.

According to this aspect, the bending movement or squatting movement of the user is suppressed. Therefore, the replacement work of the battery is facilitated.

In this case, the electric two-wheeled vehicle may further include a storage portion (924) that is formed integrally with the battery receiving portion, and that is provided above the battery receiving portion.

According to this aspect, tools and the like are stored in the storage portion.

In this case, the electric two-wheeled vehicle may further include an inner lid (925) that partitions the battery receiving portion and the storage portion off from each other, and that is attachable to and detachable from the vehicle body frame.

According to this aspect, tools and the like stored in a small item storage portion do not come into contact with the battery. Therefore, the release of the locking between a placement member and the battery receiving portion, which is caused by the downward pushing of the battery due to the weight of the tools and the like stored in the small item storage portion, is suppressed.

In this case, a switch unit (941) that receives an operation to move the assist device may be provided on a lid portion side.

According to this aspect, in the work of receiving the battery in the battery receiving portion and the work of removing the battery from the battery receiving portion, the bending movement or squatting movement of the user is suppressed. Therefore, the work of attaching and detaching the battery to and from the electric two-wheeled vehicle is facilitated.

In this case, the electric two-wheeled vehicle may further include a control device (944) for controlling an operation of the assist device and a sensor unit (946) that detects the closed state and the open state of the lid portion. The control device suppresses the operation of the assist device when the lid portion is in the closed state, and allows the operation of the assist device when the lid portion is in the open state.

According to this aspect, during traveling of the electric two-wheeled vehicle, the unintended operation of the assist device by the user is suppressed. In addition, the pressing of the switch unit by tools or the like stored in the small item storage portion is suppressed.

### REFERENCE SIGNS LIST

### First Embodiment

S1: conveyance seat (seat)
1: bottom plate
2: plate body portion
3: plate outer peripheral portion
4: attaching member (tacker needle)
5: through-hole
10: pad material
11: pad body portion
12: pad projecting portion
13: pad recess
20: skin material (conveyance skin material)
   20a: front surface material
   20b: back surface material
22: skin connecting portion
30: first skin material
   30b: back surface material
31: first skin body
32: first skin connecting portion (first skin terminal portion)
40: second skin material
   40b: back surface material
41: second skin body
42: second skin connecting portion (second skin terminal portion)
45: third skin material
46: fourth skin material
50: stitching portion
51: first stitching portion
52: second stitching portion
53: stitching line
60: waterproof member (waterproof tape)
   60a: base material
   60b: adhesive layer
61: waterproof body portion
62: first end portion
63: second end portion
64: first impregnated portion
65: second impregnated portion
66: third impregnated portion
B1, B2: boundary portion

### Second to Fifth Embodiments

S2, S3, S4, S5: conveyance seat (seat)
110, 210, 310, 410: pad material
120, 220, 320, 420: skin material
122, 322, 422: skin connecting portion
130, 230, 330, 430: first skin material
131: first skin body
132, 232: first skin connecting portion
140, 240, 340, 440: second skin material
141: second skin body
142, 242: second skin connecting portion
150, 250, 350, 450: stitching portion
160, 260, 360, 460: waterproof member (waterproof tape)
161: waterproof body portion
162: first end portion
163: second end portion
164, 264: first impregnated portion
165, 265: second impregnated portion
266: third impregnated portion
270: decorative member
370, 470: seat heater

### Sixth Embodiment

S6: conveyance seat (seat)
501: bottom plate
502: plate body portion
503: plate outer peripheral portion
504: attaching member (tacker needle)
505: through-hole
510: pad material
511: pad body portion
512: pad projecting portion
513: pad recess
520: skin material (conveyance skin material)
520a: front surface material
520b: back surface material
522: skin overlapping portion
530: first skin material
531: first skin body
532: first skin overlapping portion
533: first skin terminal portion (extension portion)
540: second skin material
541: second skin body
542: second skin overlapping portion (second skin terminal portion)
545: third skin material
546: fourth skin material
550: stitching portion
551: first stitching portion
552: second stitching portion
553: stitching line
560: waterproof member (waterproof tape)
561: waterproof body portion
562: one end portion
563: the other end portion
D: step

### Seventh to Ninth Embodiments

S7, S8, S9: conveyance seat (seat)
601, 801: bottom plate
606: reinforcing recess
805: through-hole
610, 710, 810: pad material
620, 720, 820: skin material
630, 730, 830: first skin material
631, 731, 831: first skin body
632, 732, 832: first skin overlapping portion
633, 733, 833: first skin terminal portion
640, 740, 840: second skin material
641, 741, 841: second skin body
642, 742, 842: second skin overlapping portion (second skin terminal portion)
650, 750, 850: stitching portion
651: first stitching portion
652: second stitching portion
653: third stitching portion
660, 760, 860: waterproof member (waterproof tape)

### First to Fourth Embodiments of Electric Two-Wheeled Vehicle

901: electric two-wheeled vehicle
902: operating handlebars
903: seat
904: footrest portion
906: first battery (battery)
907: meter
908: second battery
910: vehicle body frame
912: front wheel
914: rear wheel
915: front fork
916: drive unit
918: vehicle body cover
920: storage box
922: battery receiving portion
924: small item storage portion (storage portion)
925: inner lid
926: first lid portion (lid portion)
927: protruding piece
928: through-hole
929: pivot shaft
932: assist device
933: elastic member
934: placement member
935: locking means
936: connector
940: casing
941: switch unit
942, 943: switch
944: control device
946: sensor unit
952: first member
953: second member
954: opening

1. A conveyance skin material that is used for a conveyance, comprising:
a first skin material;
a second skin material connected to the first skin material; and
a waterproof member having a sheet shape, extending along a skin connecting portion that connects the first skin material and the second skin material, and covering the skin connecting portion from a back surface side of the conveyance skin material,
wherein the waterproof member includes a first impregnated portion with which a back surface material of the first skin material is impregnated, and a second impregnated portion with which a back surface material of the second skin material is impregnated,
the waterproof member is attached to the first skin material by the first impregnated portion, and is attached to the second skin material by the second impregnated portion, and
the first impregnated portion and the second impregnated portion are disposed at positions where the skin connecting portion is sandwiched between the first impregnated portion and the second impregnated portion.

2. The conveyance skin material according to claim 1,
wherein the waterproof member includes a waterproof body portion that comes into contact with a back surface of the skin connecting portion, a first end portion that is provided at one end portion of the waterproof member in a width direction and that comes into contact with a back surface of the first skin material, and a second end portion that is provided at the other end portion of the waterproof member in the width direction and that comes into contact with a back surface of the second skin material,
the first impregnated portion is formed at least at a boundary portion between the waterproof body portion and the first end portion, and
the second impregnated portion is formed at least at a boundary portion between the waterproof body portion and the second end portion.

3. The conveyance skin material according to claim 2,
wherein the skin connecting portion is folded toward a second skin material side and disposed on the back surface side of the conveyance skin material, and is attached in a folded state by a stitching portion, and
the second impregnated portion passes through the back surface material of the folded second skin material, and extends from the boundary portion between the waterproof body portion and the second end portion toward the stitching portion.

4. The conveyance skin material according to claim 1,
wherein the skin connecting portion is folded toward a second skin material side and disposed on the back surface side of the conveyance skin material, and is attached in a folded state by a stitching portion,
the stitching portion extends along the skin connecting portion, and
the first impregnated portion and the second impregnated portion extend along the stitching portion.

5. The conveyance skin material according to claim 4,
wherein the waterproof member includes the first impregnated portion, the second impregnated portion, and a third impregnated portion with which a back surface material of the skin connecting portion is impregnated, and which is formed continuously with the first impregnated portion and the second impregnated portion, and
the first impregnated portion, the second impregnated portion, and the third impregnated portion extend continuously along the stitching portion.

6. The conveyance skin material according to claim 1, further comprising:
a decorative member attached between a first skin connecting portion of the first skin material and a second skin connecting portion of the second skin material, the first skin connecting portion and the second skin connecting portion constituting the skin connecting portion, and exposed on a front surface of the conveyance skin material,
wherein the waterproof member includes the first impregnated portion, the second impregnated portion, and a third impregnated portion with which a back surface material of the skin connecting portion is impregnated, and
a part of the third impregnated portion is provided at a position facing an end portion of the decorative member.

7. A conveyance seat, comprising:
the conveyance skin material according to claim 1; and
a pad material covered with the conveyance skin material,
wherein the skin connecting portion and the waterproof member are accommodated in a pad recess formed on a front surface of the pad material.

8. The conveyance seat according to claim 7,
wherein the waterproof member includes a waterproof body portion that comes into contact with a back surface of the skin connecting portion, a first end portion that is provided at one end portion of the waterproof member in a width direction and that comes into contact with a back surface of the first skin material, and a second end portion that is provided at the other end portion of the waterproof member in the width direction and that comes into contact with a back surface of the second skin material, and
each of the first end portion and the second end portion comes into contact with the front surface of the pad material.

9. The conveyance seat according to claim 7,
wherein a bottom plate, the pad material disposed on the bottom plate, and the conveyance skin material covering the bottom plate and the pad material are provided,
a plurality of through-holes are formed on a front surface of the bottom plate, and
at least a part of the skin connecting portion is disposed at a position overlapping the through-holes of the bottom plate when the conveyance seat is viewed from above.

10. The conveyance seat according to claim 7, further comprising:
a seat heater disposed between the pad material and the conveyance skin material,
wherein the seat heater is disposed on a front surface of the conveyance skin material at a position different from a position of the waterproof member.
